(19) United States
(12) Patent Application Publication
(10) Pub. No.: US 2026/0242010 A1
(43) Pub. Date: Aug. 20, 2026

(54) Adjustable Rolling Cargo Tray

(71) Applicant: Truck Accessories Group, LLC d/b/a Leer Group, Elkhart, IN (US)

(72) Inventors: Eugene A. Dylewski, II, Granger, IN (US); Harley D. Harrison, South Bend, IN (US); Tommy C. Brock, Nappanee, IN (US); Mark W. Young, Nile, MI (US)

(21) Appl. No.: 19/539,332

(22) Filed: Feb. 13, 2026

Related U.S. Application Data
(60) Provisional application No. 63/758,456, filed on Feb. 14, 2025.

(51) Int. Cl. B62D 33/027

(52) U.S. Cl. CPC B62D 33/0273

(57) ABSTRACT

An adjustable cargo tray assembly for a cargo box of a vehicle is provided. The adjustable cargo tray assembly for a cargo box of a vehicle includes a tray having a first deck portion and a second deck portion. The first deck portion being selectively adjustable with respect to the second deck portion to adjust an overall length of the tray. At least one adjustable roller frame assembly including a first roller frame and a second roller frame telescopically received within the first roller frame. The second roller frame is extendable or retractable to adjust a length of the at least one adjustable roller frame assembly. One or more wheels are mounted on the at least one adjustable roller frame assembly to allow rolling movement of the tray along a cargo box floor.

### RELATED APPLICATION

The present Application relates to and claims priority to U.S. Provisional Patent Application, Serial No. 63/758456, filed on February 14, 2025, entitled “Adjustable Rolling Cargo Tray.” The subject matter disclosed in that Provisional Application is hereby expressly incorporated into the past Application.

### TECHNICAL FIELD AND SUMMARY

The present disclosure relates to trucks, such as pickup trucks, and truck beds or cargo boxes used on pickup trucks and like vehicles. In particular, the present disclosure relates to an adjustable rolling cargo tray, movable into and out of the cargo box while being adjustably sized to fit into cargo boxes of different sizes.

A truck bed or cargo box is the large open space of a pickup truck located behind its cab section. The cargo box is typically composed of a floor bounded by opposing sidewalls. A bulkhead is a wall extending between the opposed sidewalls and is located adjacent the cab section. A tailgate is located opposite the bulkhead at the rear end of the cargo box and is movable between open and closed positions.

Pickup truck cargo boxes may be of any variety of sizes based on the make, model, and year. Some cargo boxes are large, having a correspondingly large floor space, others relatively small, and a myriad of others in-between. For example, such cargo box sizes may include full, short, and extra short truck beds from about 82 to about 65 inches, as well as compact truck beds from about 73 to about 53 inches. Because cargo boxes come in different sizes, any bedslide or other cargo box slide-out mechanism may, likewise, come in different sizes to so accommodate.

The adjustable cargo tray of the present disclosure is configured to move along a floor surface of the cargo box. A tray assembly sits on top of one or more adjustable roller frame assemblies that allow the tray to roll in and out of the cargo box, as well as onto the tailgate when lowered to its open position. Illustratively, the length of frame portions of the adjustable roller frame assembly is extendable and retractable to accommodate the adjustability and size of the tray assembly. Each frame assembly can be made of telescoping frame portions that extend and retract with respect to each other and hold wheels so the frame length is consistent with the tray length. Additionally, the adjustable roller frame assemblies can be positioned laterally with respect to each other and the tray. This allows the wheels to be adjusted so they can fit within the spaced apart flats on the cargo box floor.

Accordingly, an illustrative embodiment of the present disclosure provides an adjustable cargo tray assembly for a cargo box of a vehicle. The adjustable cargo tray assembly comprises a tray having a first deck portion and a second deck portion. The first deck portion and the second deck portion are selectively overlapped to adjust an overall length of the tray. At least two adjustable roller frame assemblies. Each of the adjustable roller frame assemblies include a first roller frame and a second roller frame telescopically received within the first roller frame. The second roller frame is extendable or retractable to adjust a length of each of the adjustable roller frame assemblies. A plurality of wheels mounted on the each of the adjustable roller frame assemblies to allow rolling movement of the tray along a cargo box floor. Each of the adjustable roller frame assemblies is secured to the adjustable cargo tray assembly at selected positions under said tray to align the plurality of wheels with flat regions on the cargo box floor, whereby the tray and the adjustable roller frame assemblies are adjustable to fit cargo boxes of a plurality of configurations.

In the above and other illustrative embodiments, the adjustable cargo tray assembly may further comprise: each of the adjustable roller frame assemblies includes a plurality of retainers that secure the each of the adjustable roller frame assemblies to the tray, each of the adjustable roller frame assemblies includes at least one retainer that secures the each of the adjustable roller frame assemblies to the tray, the tray includes a plurality of recesses with fastener holes each configured to receive a retainer of the plurality of retainers to secure the each of the adjustable roller frame assemblies to the tray, the plurality of wheels are positioned within channels formed by at least one leg on the each of the adjustable roller frame assemblies, markings are provided on the tray to guide drilling of fastener holes for custom positioning of the each of the adjustable roller frame assemblies, the each of the adjustable roller frame assemblies is independently laterally adjustable under the tray, at least one adjustable tether assembly having a tether extendably coupled to the adjustable cargo tray assembly and configured to couple to a tie-down of the cargo box, the at least one adjustable tether assembly includes a tether rod mounted to at least one of the adjustable roller frame assemblies via one or more spaced-apart brackets, wherein the tether is coupled to the tether rod and configured to couple to the tie-down of the cargo box, the at least one adjustable tether assembly includes a stop block adjustably positionable along the tether rod to limit movement of the tray in at least an extend direction, the stop block is selectively securable to the tether rod via a setscrew disposed through the stop block, the tether is removably attachable to the tether rod and configured to be removably attachable to the tie-down of the cargo box, a secondary tether configured to be attached to the tether and coupled to the tray to restrict movement of the tray until the secondary tether is uncoupled from the tray, a tray retraction stop assembly pivotally mounted on at least one adjustable roller frame assembly adjacent a leading edge of the tray, the tray retraction stop assembly includes a stop frame configured to pivot downward when the tray is extended past a lowered tailgate, the tray retraction stop assembly includes at least one wheel mounted to the stop frame configured to engage an end surface of the lowered tailgate and inhibit unintentional retraction of the tray, the tray retraction stop assembly includes a handle configured to be operable by a user to pivot the stop frame upward to clear the lowered tailgate to permit the retraction of the tray into the cargo box, and the tray retraction stop assembly includes spaced-apart wheels configured to prevent the stop frame from dropping into a gap between the cargo box floor and the lowered tailgate, wherein the stop frame further limits forward tilting of the tray when extended past the lowered tailgate, and wherein the handle is accessible by an opening in the tray near the leading edge.

Another illustrative embodiment of the present disclosure provides an adjustable cargo tray assembly for a cargo box of a vehicle. The adjustable cargo tray assembly for a cargo box of a vehicle comprises a tray having a first deck portion and a second deck portion. The first deck portion being selectively adjustable with respect to the second deck portion to adjust an overall length of the tray. At least one adjustable roller frame assembly including a first roller frame and a second roller frame telescopically received within the first roller frame. The second roller frame is extendable or retractable to adjust a length of the at least one adjustable roller frame assembly. A plurality of wheels mounted on the at least one adjustable roller frame assembly to allow rolling movement of the tray along a cargo box floor.

In the above and other illustrative embodiments, the adjustable cargo tray assembly may further comprise: the at least one adjustable roller frame assembly being secured to the adjustable cargo tray assembly at selected positions under said tray to align the plurality of wheels with flat regions on the cargo box floor, and wherein the tray and roller frame assemblies are adjustable to fit cargo boxes of a plurality of configurations.

Additional features and advantages of the adjustable cargo tray assembly will become apparent to those skilled in the art upon consideration of the following detailed descriptions of carrying out the adjustable cargo tray assembly as presently perceived.

### BRIEF DESCRIPTION OF THE DRAWINGS

The present disclosure will be described hereafter with reference to the attached drawings which are given as non-limiting examples only, in which:

FIG. 1 is a perspective view of a cargo box with an adjustable truck bed cargo tray assembly shown in its retracted position;

FIG. 2 is a perspective view of the cargo box of FIG. 1 with the adjustable truck bed cargo tray assembly in its extended position over the tailgate;

FIG. 3 is a front cross-sectional view of the cargo box showing the adjustable truck bed cargo tray assembly supported by adjustable roller frame assemblies;

FIG. 4 is a detail cross-sectional view of the adjustable truck bed cargo tray assembly showing the attachment of an adjustable roller frame assembly to the tray as well as a portion of the adjustable tether assembly;

FIG. 5 is a perspective view of an illustrative adjustable roller frame assembly showing telescoping roller frames and a plurality of wheels;

FIG. 6 is a perspective view of an adjustable roller frame assembly with an attached tray retraction stop assembly at its front end;

FIG. 7 is a perspective exploded view of a roller frame showing J-type nut retainers, openings, wheels, axle pins, bushings, and attachment details;

FIG. 8 is a perspective view of a roller frame configured to fit onto another roller frame for telescopic adjustment and attachment of wheels;

FIG. 9 is an exploded perspective view of a tray retraction stop assembly including a stop frame, wheels, pivot handle, and pivot axis;

FIG. 10 is an isolated detail perspective view of an adjustable tether assembly, including a tether rod, brackets, stop blocks, and tether;

FIG. 11 is a contrasting detail perspective view of the adjustable truck bed cargo tray assembly moved in retraction and extension directions, showing how the adjustable tether assemblies limit travel;

FIG. 12 is a perspective detail view of the adjustable truck bed cargo tray assembly coupled to a cargo box, showing the roller frame assembly and tether attachment at the tiedown point;

FIG. 13 is a perspective detail view of the tray extending outward over the tailgate, illustrating the function of the tether assembly in limiting tray extension;

FIG. 14 is a perspective detail view showing tether attachment to a cargo box wall and the limitation of travel by the adjustable tether assembly;

FIG. 15 is an underside detail view of the tray partially extended from the tailgate, showing the support provided by the roller frame assemblies and the retracted position of the tray retraction stop assembly;

FIG. 16 is a detail perspective view similar to FIG. 15 showing the tray retraction stop assembly pivoted downward after the tray clears the tailgate;

FIG. 17 is a perspective detail view showing the tray retraction stop assembly pivoted downward and abutting the end surface of the tailgate to prevent retraction;

FIG. 18 is a side detail sectional view showing the tray retraction stop assembly engaged with the tailgate and the operation of the lever handle for disengaging the stop;

FIG. 19 is a side sectional view similar to FIG. 18 showing the lever handle depressed further to lift the stop assembly away from the tailgate, enabling retraction of the tray;

FIG. 20 is a side perspective partial cutaway view of a cargo box with the tray held in position by abutment between the tray and the closed tailgate using the tether assembly;

FIG. 21 is a detail perspective partial cutaway view showing the tether assembly securing the tray within the cargo box with the tailgate in the upright and latched condition;

FIG. 22 is a detail underside view showing lateral positioning of a roller frame assembly in one lateral direction under the tray;

FIG. 23 is a detail underside view showing lateral positioning of the roller frame assembly in the opposite lateral direction;

FIG. 24 is a perspective end detail view of a roller frame showing the J-type nut retainer moved to one lateral extent in its mounting opening;

FIG. 25 is a perspective end detail view of the roller frame showing the J-type nut retainer moved to the opposite lateral extent;

FIG. 26 is an isolated end detail view showing the roller frame positioned for the wheels to fit in a flat section adjacent a rib of the cargo box;

FIG. 27 is an isolated end detail view showing the roller frame positioned with wheels in a differently spaced flat section on the cargo box;

FIG. 28 is a detail perspective view of a portion of a cargo box showing a secondary tether assembly limiting initial movement of the tray;

FIG. 29 is a forward-looking detail view of the cargo box, tray, and secondary tether assembly secured to a tiedown, limiting tray extension;

FIG. 30 is an isolated perspective view of a tray portion with spaced-apart tiedown rings attached to the sidewall;

FIG. 31 is a detail perspective view showing a tiedown ring fastened to a tray sidewall with a bungee cord attached through the ring opening;

FIG. 32 is a perspective partial cutaway view of cargo box with modular containers of varying depths positioned within the tray;

FIG. 33 is an isolated perspective view of the tray with modular containers of different depths;

FIG. 34 is a cross-sectional side view of the tray and modular containers, showing depending feet of containers fitted within indexing ribs;

FIG. 35 is a detail sectional view of a modular container positioned on the tray with feet depending into indexing ribs;

FIG. 36 is a side detail view of a modular container and tray, with depending feet fitted into indexing ribs;

FIG. 37 is a sectional view showing stacking of modular containers of varying depths atop each other in the tray;

FIG. 38 is a side detail sectional view of the cargo box and tray, showing the tray tipped forward and the tray retraction stop assembly engaged to limit tilting;

FIG. 39 is a detail underside perspective view showing drill markings on the tray for custom placement of roller frame assemblies;

FIG. 40 is a perspective view of the cargo box portion with a secondary tether directly attached to a carabiner at a tiedown location; and

FIG. 41 is an isolated detail perspective view of an adjustable tether assembly with secondary tether attached via a carabiner and ring.

Corresponding reference characters indicate corresponding parts throughout the several views. The exemplification set out herein illustrates embodiments of the adjustable cargo tray assembly, and such exemplification is not to be construed as limiting the scope of the adjustable cargo tray assembly in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides an adjustable cargo tray assembly. The adjustable cargo tray assembly sets onto the cargo box of a pickup truck and is extendable and retractable relative thereto. The adjustable bedslide assembly includes a deck assembly that is composed of a first deck portion and a second deck portion. In an illustrative embodiment, the first deck portion includes a plurality of ribs being regularly spaced along the first deck portion. The second deck portion also includes a plurality of ribs being regularly spaced along the second deck portion. At least one rib of the plurality of ribs of the first deck portion engages at least one rib of the plurality of ribs of the second deck portion. The first deck portion can overlap with the second deck portion so the deck assembly is adjustably sizable to fit within dimensions of a variety of cargo boxes. Such adjustable trays or decks, as disclosed herein, are further described in US Patent Application No. 18/381286, titled “Adjustable Bedslide Deck,” the disclosure of which is incorporated herein in its entirety.

Another illustrative embodiment of the present disclosure provides the adjustable cargo tray with an adjustable tether assembly including a tether and adjustable tether rod. Depending on the configuration of the cargo box bed, a tether rod may be placed in different positions along each side of the adjustable tray assembly to provide for a range of extension and retraction of the adjustable tray assembly. In an embodiment, the tether rod may be coupled to the adjustable roller frame assembly. A strap or tether may illustratively be attached to a tie-down on the cargo box sidewall adjacent the tailgate end and on the adjustable cargo tray assembly movably coupled to the tether rod. This allows the adjustable cargo tray to extend from and retract into the cargo box while limiting that amount of extension and retraction. Tether limiters located on the tether rod can be adjustably set to customize the limit of the extent to which the adjustable cargo tray extends into or retracts from the cargo box. The limiters are adjustable along the tether rod to provide precise extension and retraction tolerances.

Additionally, the adjustable tether assembly limits the extent to which the adjustable tray can be recessed within the cargo box so that a front end of the adjustable cargo tray abuts the inner wall of the tailgate when closed. This is a way to hold the adjustable cargo tray in place and even limit movement and/or rattle within the cargo box while the pickup truck is moving.

Another illustrative embodiment of the present disclosure provides the adjustable tray assembly with a tray retraction stop assembly that selectively limits the extent to which the adjustable cargo tray can retract back into the cargo box while in use. When the adjustable rolling cargo tray is extended onto the tailgate and articles, such as a bags of feed or seed, for example, are tossed into the cargo box from the tailgate end, those articles exert both downward and forward directional forces onto the tray which might cause the same to unintentionally retract back into the cargo box. The tray retraction stop assembly prevents this by illustratively providing a stop arm that automatically extends from a roller frame assembly and engage or abut the end (or top) of the lowered tailgate. With the stop arm extending downward, the adjustable cargo tray cannot retract without that top arm being lifted to clear the end of the tailgate. Such impact will, therefore, not cause the adjustable rolling cargo tray to retract back into the cargo box until an operator intentionally disengages the stop arm.

In an illustrative embodiment, a plurality of rollers can be placed on the stop arm of the tray retraction stop assembly to prevent marring or other cosmetic damage from occurring on the end of the tailgate. In a further illustrative embodiment, two rollers or wheels are affixed to the stop arm. Having two spaced-apart rollers on the stop arm assists in preventing the stop arm from being hung up on a gap that exists between the tailgate and the cargo box floor. This gap is evident when the tailgate is lowered. Two wheels offer support so that one wheel does not fall into the gap between the tailgate and the cargo box floor.

In an alternate embodiment, a single wheel of the tray retraction stop assembly may be used on the stop arm to engage the top or end of the tailgate to prevent damage to same, as well as fit in the gap between the tailgate and the cargo box floor. The single wheel on the tray retraction stop assembly can provide a predetermined stop position for the adjustable tray assembly. Moving the stop arm may release the wheel from the gap between the tailgate and cargo box floor to allow extension or retraction of the adjustable rolling cargo tray as normal. It is appreciated that in further embodiments, the gap between the tailgate and cargo box floor, when the tailgate is in its open position, can be leveraged to selectively engage portions of the adjustable cargo tray assembly to provide multiple stop positions of same while extending or retracting.

Another illustrative embodiment of the present disclosure provides an anti-tray tip feature that limits the extent to which the tray can pivot forward when extended from the tailgate. In further embodiments, modular containers can be positioned on the tray to provide additional utility to same. The containers include feet extending therefrom that fit between ribs on the tray to limit the containers’ movement while sitting on the tray. Further, in another illustrative embodiment, a secondary strap or tether can be removably attached to the tray to limit initial movement of same from the cargo box when the tailgate is first opened.

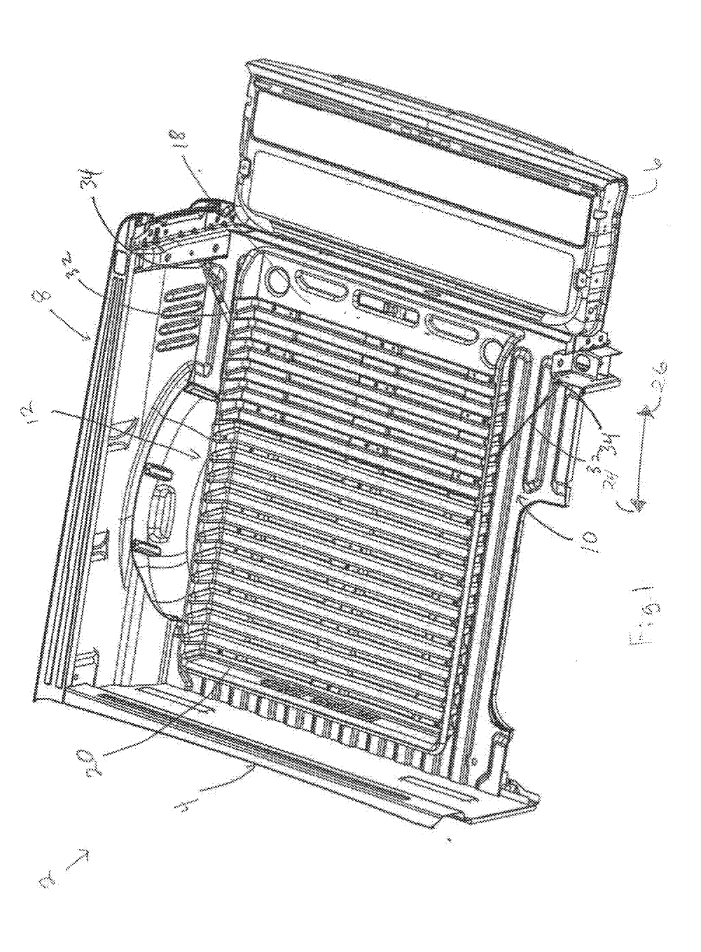

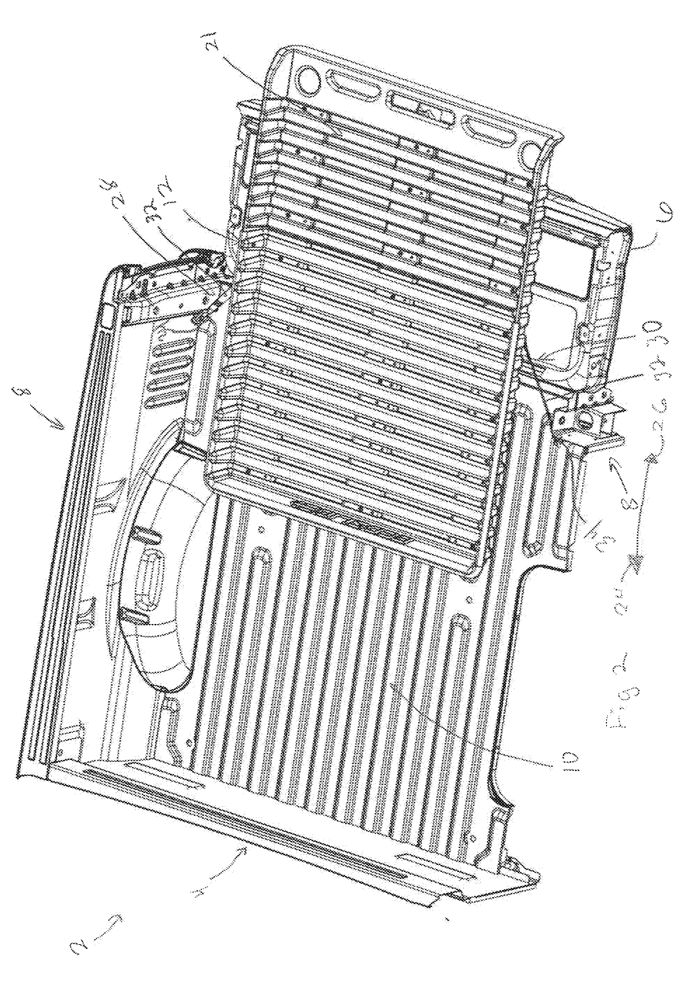

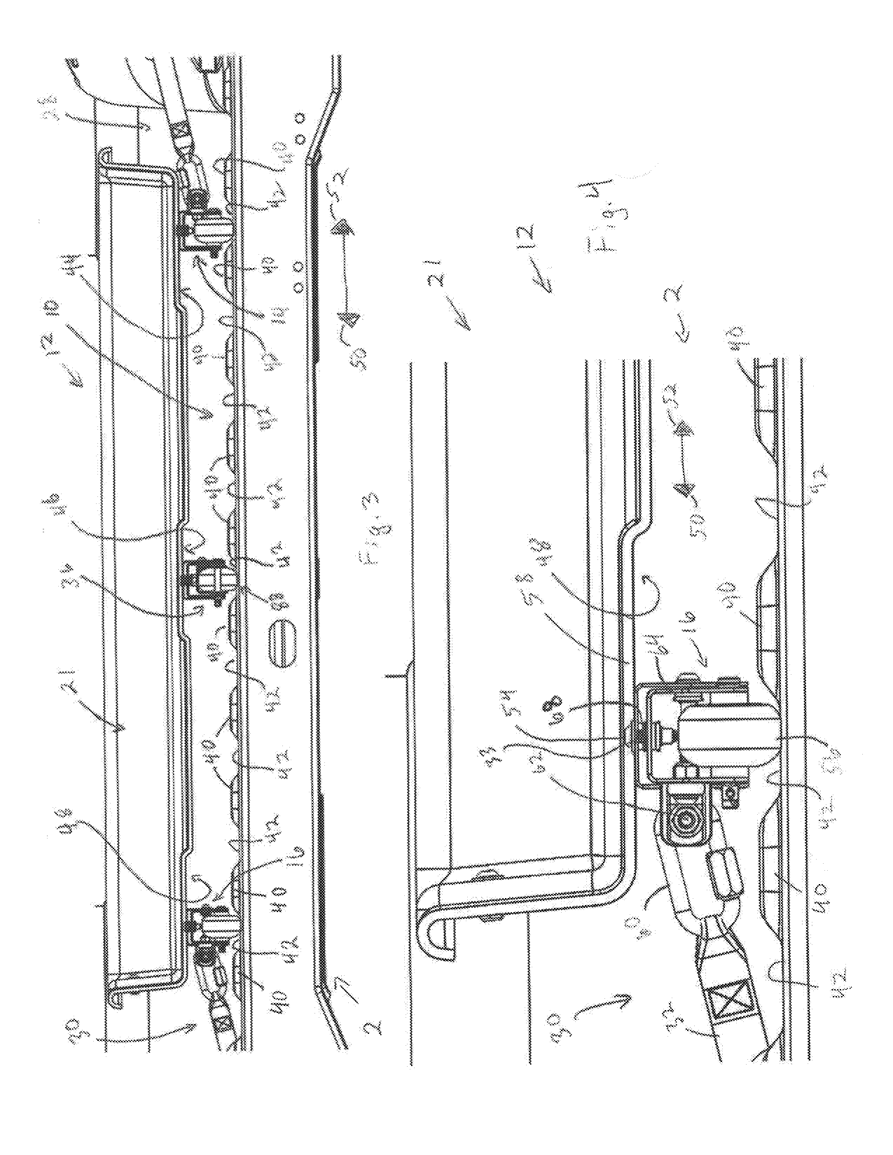

Perspective views of a cargo box 2 are shown in FIGS. 1 and 2. Cargo box 2 includes a bulkhead 4, tailgate 6, and opposing sidewalls 8. Illustratively, one of the sidewalls is removed to better view cargo box floor 10 as shown. Attached to cargo box floor 10 is an adjustable truck bed cargo tray assembly 12. Such an adjustable truck bed cargo tray assembly 12 can be useful to load articles commonly placed in cargo boxes onto adjustable truck bed cargo tray assembly 12 so those articles can be rolled into and out of cargo box 2 as desired. In FIG. 1, adjustable truck bed cargo tray assembly 12 is shown in its retracted position with respect to cargo box 2. Adjustable truck bed cargo tray assembly 12 includes adjustable roller frame assemblies 14, 16, and 36 (see, e.g., FIG. 3). Adjustable roller frame assemblies 14, 16, and 36 roll on cargo box floor 10 of cargo box 2. Adjustable roller frame assemblies 14, 16, and 36 are also attached to a first deck portion 18 and a second deck portion 20 that are coupled together forming tray 21 which fits within cargo box 2. It is appreciated that the configuration of tray 21 may be a pan, flat deck, or other suitable support platform that can be moved along cargo box floor 10 on one or more of adjustable roller frame assemblies 14, 16, and 36.

The perspective view of cargo box 2 shown in FIG. 2 depicts adjustable truck bed cargo tray assembly 12 in an extended position from cargo box 2. Here, tailgate 6 supports a portion of adjustable truck bed cargo tray assembly 12. Also shown in this view are adjustable tether assemblies 28 and 30, each located on opposed sides of tray 21 securing same to sidewalls 8 of cargo box 2. This limits the extent to which adjustable truck bed cargo tray assembly 12 can extend from cargo box 2. Each of adjustable tether assemblies 28 and 30 includes a tether 32 that attaches to tray 21 at a tiedown 34 located on each of sidewalls 8 as illustratively shown (see, also, FIG. 12). Conversely, when adjustable truck bed cargo tray assembly 12 is retracted in direction 24, into cargo box 2, along cargo box floor 10, tether 32 of each of adjustable tether assemblies 28 and 30 limit the extent to which tray 21 will retract within cargo box 2.

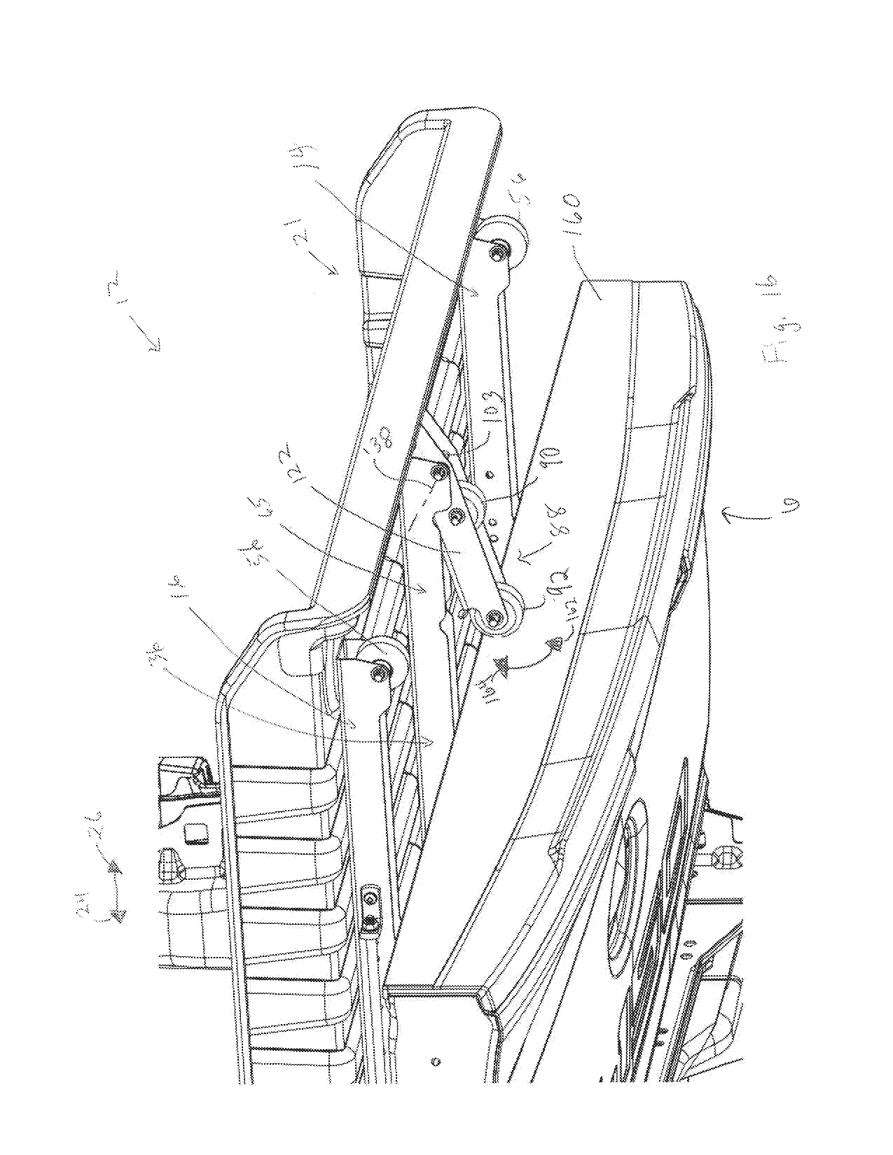

A front cross-sectional view of cargo box 2 is shown in FIG. 3. Here, adjustable truck bed cargo tray assembly 12 is shown supported on cargo box floor 10 of cargo box 2 by adjustable roller frame assemblies 14 and 16. Another adjustable roller frame assembly 36 includes a tray retraction stop assembly 88 that limits the extent to which adjustable truck bed cargo tray assembly 12 can retract back in direction 24 once it has been extended past tailgate 6 (see FIGS. 15, 16, 17, and 18).

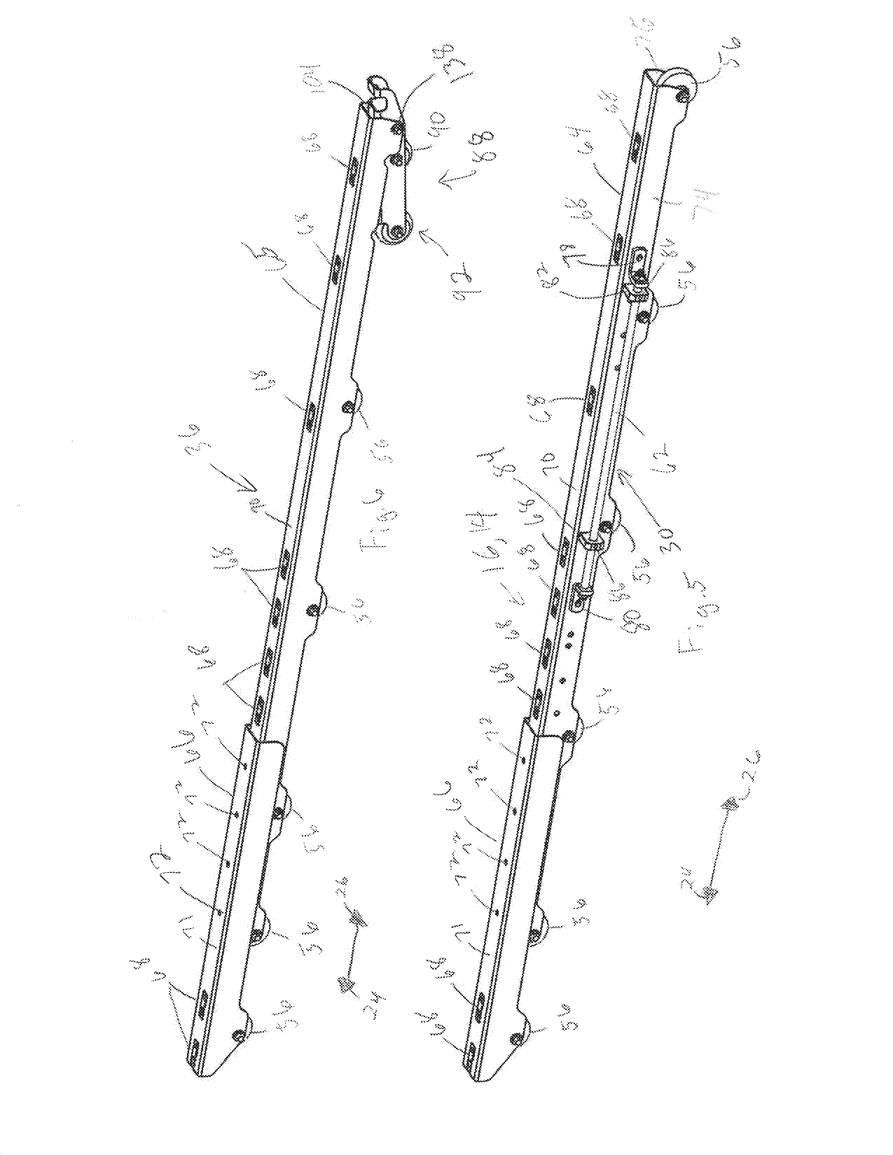

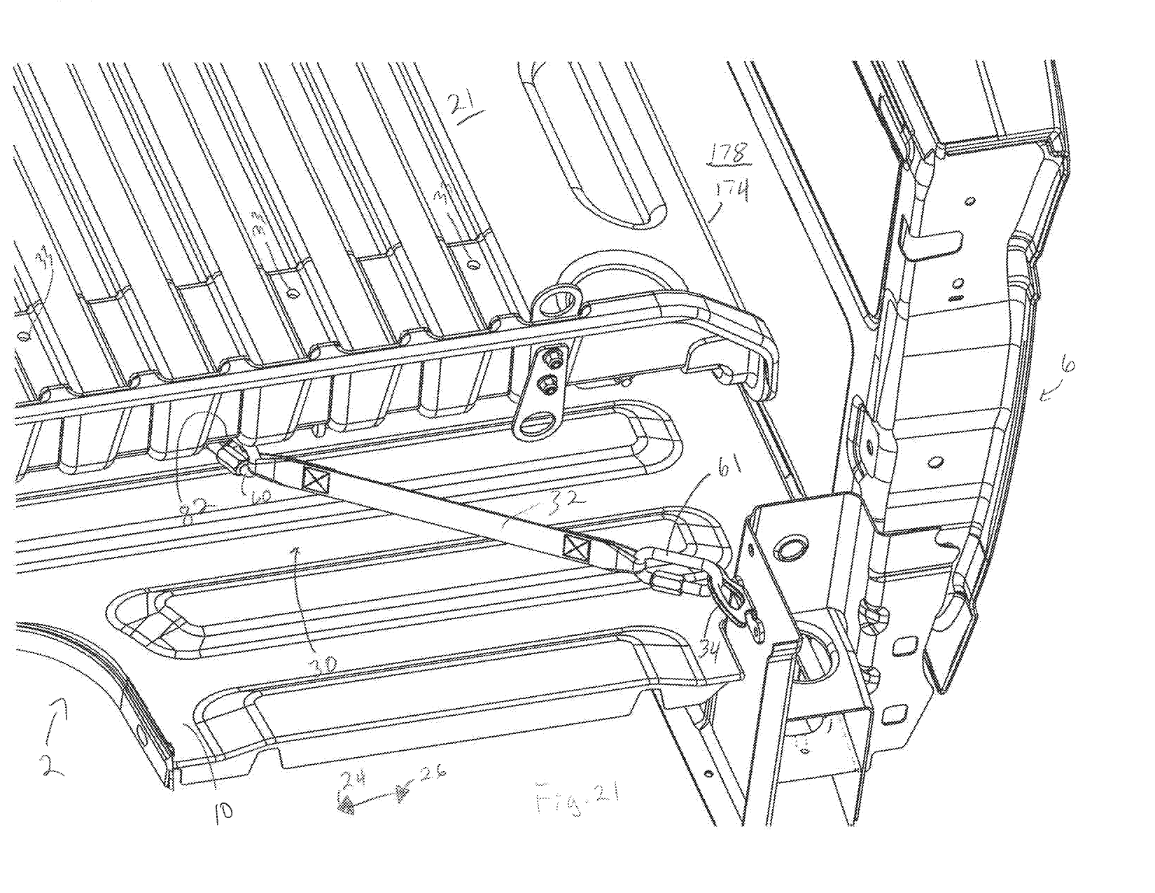

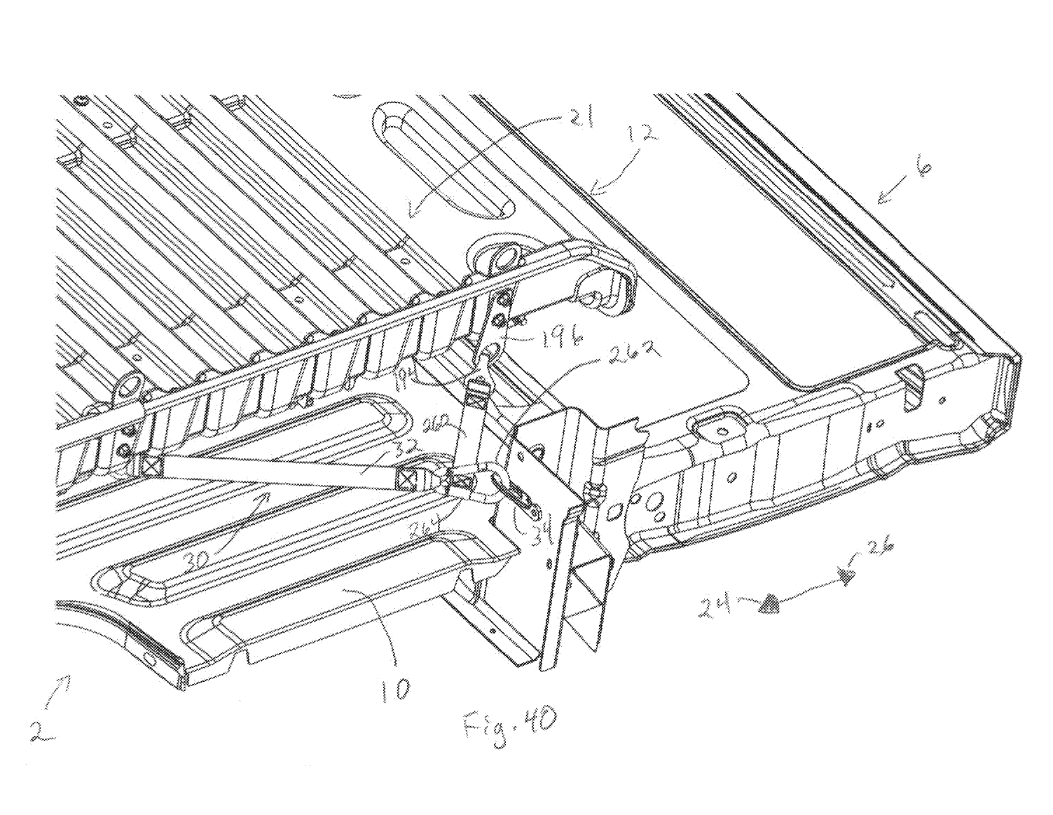

An issue with many truck cargo box floor configurations is that they include a plurality of longitudinally extending ribs 40 located adjacent corresponding flats 42 that compose cargo box floor 10. Ribs 40 and flats 42 form an alternating pattern as shown in FIG. 3. However, some pickup truck manufacturers include a rib that extends along the centerline (from front to rear) of cargo box floor 10 while other manufacturers include a flat along the centerline of the floor. Accordingly, adjustable truck bed cargo tray assembly 12 includes recessed sections 44, 46, and 48 within the underside of tray 21 (composed of first deck portion 18 and second deck portion 20). (See FIG. 1, as well as Application No. 18/381286, titled “Adjustable Bedslide Deck”). Recesses 44, 46, and 48 may include a plurality of fastener holes 33 (see, also, FIG. 4) that allow each of adjustable roller frame assemblies 14, 16, or 36 to be moved laterally in either directions 50 or 52 (see, also, FIGS. 22-28). Alternatively, a single or no holes can be provided and replaced with predefined bore markings (see FIG. 39). This allows adjustable roller frame assemblies 14, 16, and 36 to be positioned over a flat, such as flat 42, while keeping tray 21 substantially centered within cargo box 2, while avoiding ribs 40. An operator can either use fastener holes if provided or drill alternative holes as needed for the particular make and model of the cargo box. Further description of attaching adjustable roller frame assemblies 14, 16, or 36 to tray 21 is discussed with respect to FIGS. 22-27 and 39.

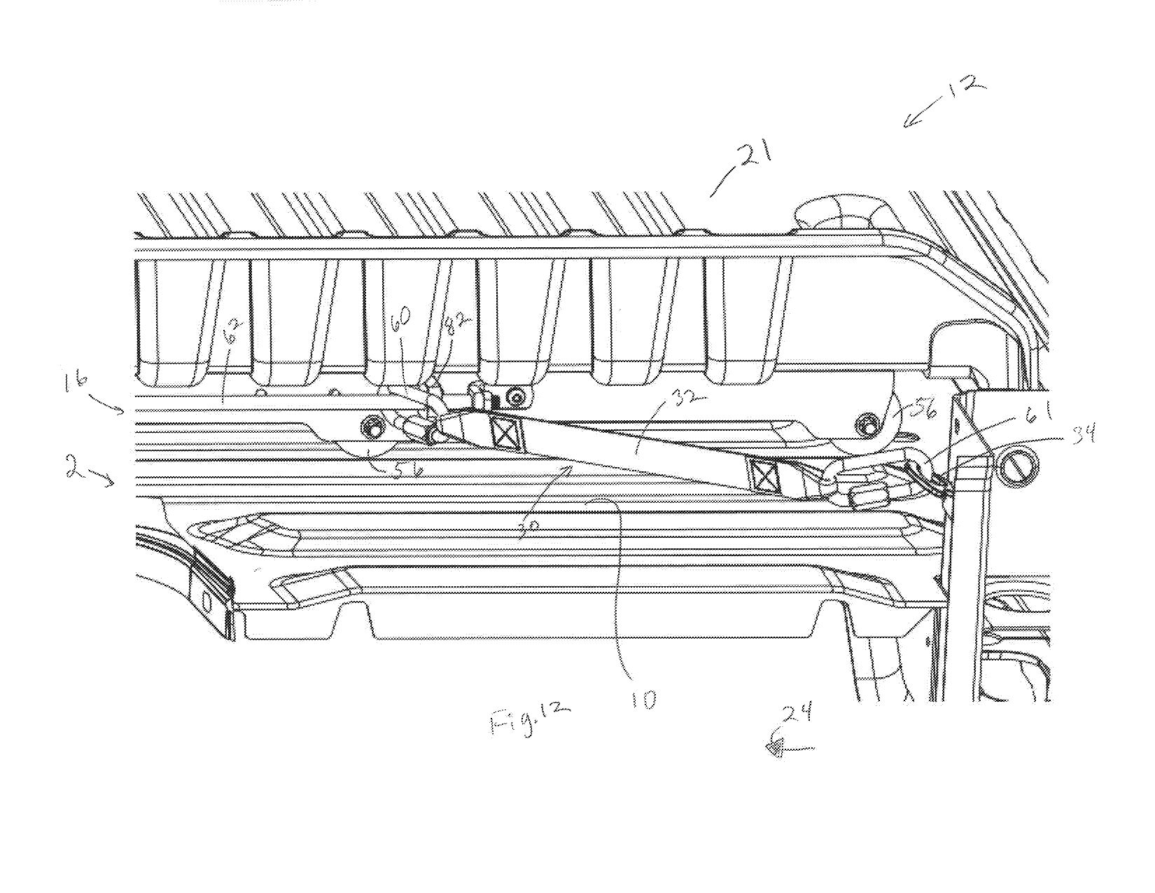

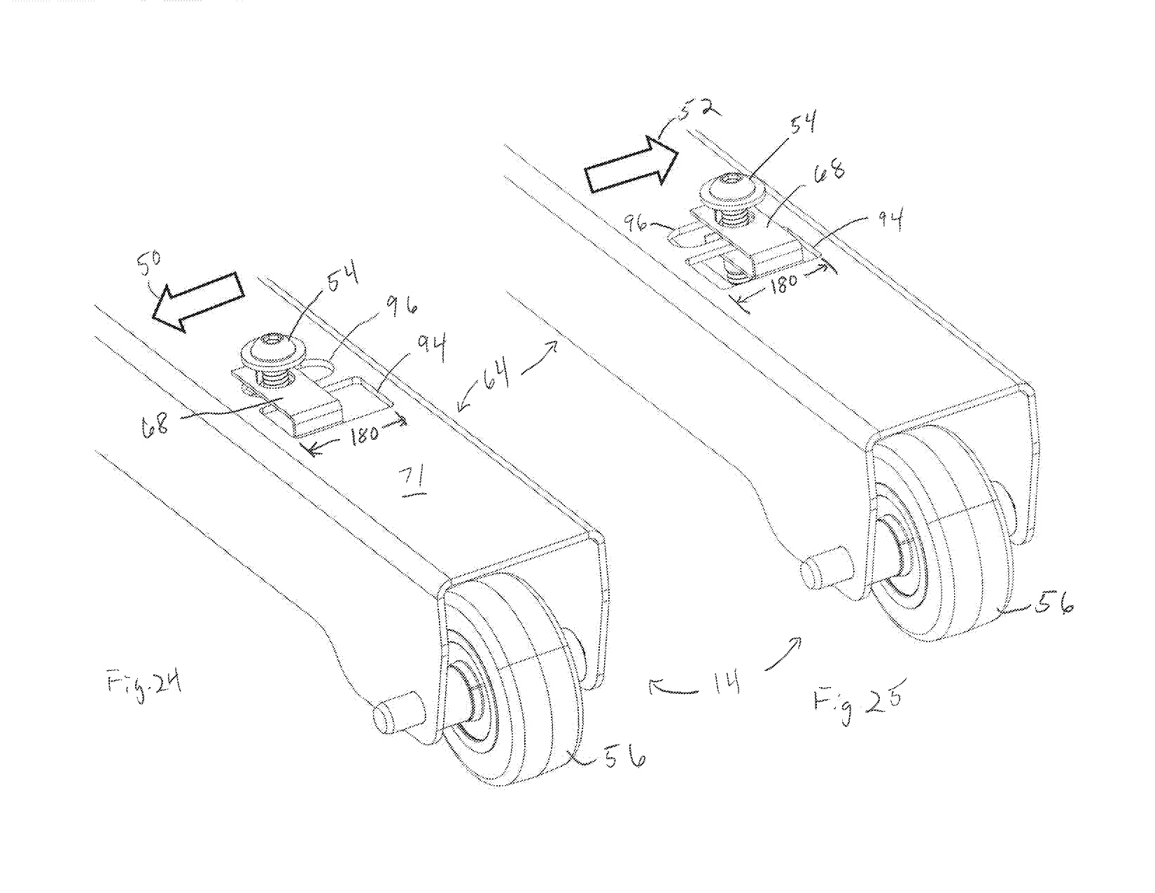

A detail cross-sectional view of adjustable truck bed cargo tray assembly 12 is shown in FIG. 4. This view shows adjustable roller frame assembly 16 from FIG. 3 attached to tray 21 via fastener 54 disposed through an illustrative J-type nut retainer 68 within recesses 48 (see FIGS. 24 and 25). It is appreciated that adjustable roller frame assembly 16 can be moved in either directions 50 or 52 and then fastened to tray 21 within recess 48 to ensure wheel 56 moves along flat 42 of cargo box floor 10. Multiple openings may be disposed through surface 58 that forms the periphery of recess 48 for locating adjustable roller frame assembly 16 at different positions to accommodate different cargo box flooring configurations. It is appreciated that such holes may be disposed through recesses 44 and 46 to accommodate different positions for adjustable roller frame assemblies 14 and 36, respectively, so they avoid ribs 40 as well. Also shown in this view is a portion of adjustable tether assembly 30 that includes tether 32 attached to carabiner or quick link 60 and adjustable tether rod 62 illustratively attached to roller frame 64 (see, also, FIGS. 10-14).

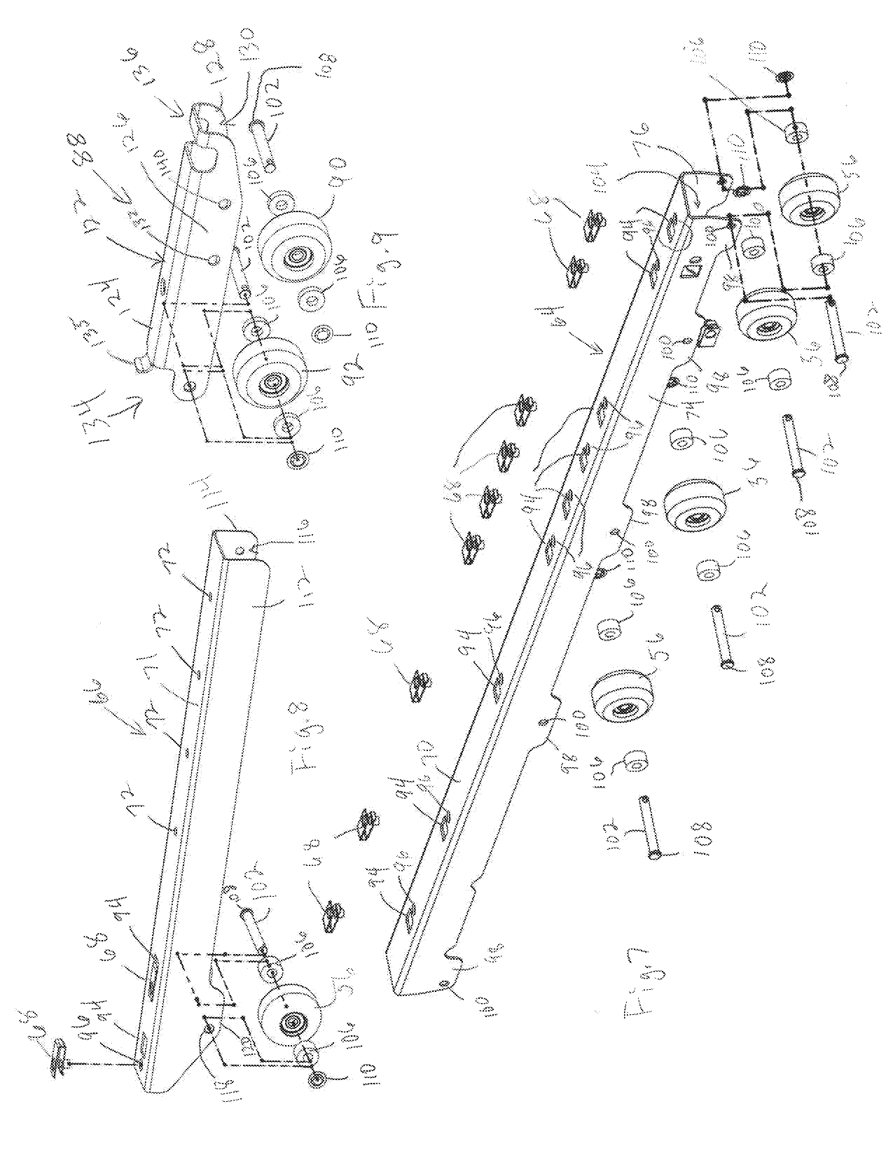

A perspective view of an illustrative example of adjustable roller frame assembly 14 or 16, as well as adjustable roller frame assembly 36 are shown in FIG. 5 and 6. It is appreciated that adjustable roller frame assembly 14 can be the same as adjustable roller frame 16, but with adjustable tether assembly 28 located on the opposite side (see FIG. 3.) Either adjustable roller frame assembly 14 or 16 includes roller frames 64 and 66. Each roller frame 64 and 66 are illustratively U-shaped channels that receive one or more wheels 56 periodically spaced thereon as shown. As demonstrated in this view, roller frame 66 overlaps a portion of roller frame 64 and is movable therefrom in a telescoping like manner in either directions 24 and 26. This allows adjustable roller frame 14 or 16 to be different lengths, depending on the length of corresponding tray 21, which, as discussed previously, depends on the length of the cargo box. For shorter cargo box floors requiring shorter trays, roller frame 66 can be moved in direction 26 with respect to roller frame 64 to create a shorter overall length for adjustable roller frame assemblies 14 or 16. Conversely, for longer truck beds that can accommodate a longer tray 21, roller frame 66 can move in direction 24 with respect to roller frame 64 to create a longer overall adjustable roller frame assembly 14 or 16. As illustratively shown, J-type nut retainers 68 are periodically spaced along top web 70 of roller frame 64 and a portion of roller frame 66 may be configured to not overlap roller frame 64. These J-type nut retainers 68 are configured to receive fastener 54 (see FIGS. 4 and 22-27) to secure adjustable roller frame assemblies 14 and 16 to tray 21. Holes 72, disposed through web 71, are configured to align underneath with corresponding J-type nut retainers 68 located on web 70 of roller frame 64. This allows a fastener 54 to extend through tray 21 and hole 72 to secure to J-type nut retainers 68, thereby holding roller frame 66 in place with respect to roller frame 64. This alignment between holes 72 and J-type nut retainers 68, regardless of the extent roller frame 66 moves in either directions 24 or 26, ensures both roller frames 64 and 66 are secured to tray 21 via a fasteners 54.

Also shown is adjustable tether assembly 30 attached to leg 74 adjacent web 70 on roller frame 64. It is appreciated that a distinction between adjustable roller frame assembly 16 from adjustable roller frame assembly 14 is that adjustable tether assembly 28 (see FIG. 3), which is substantively the same as adjustable tether assembly 30, but is attached to leg 76 located opposite leg 74 on roller frame 64. It will be appreciated by the skilled artisan upon reading this disclosure that the descriptions herein with respect to adjustable tether assembly 30 can be applied to adjustable tether assembly 28 as well. To that end, adjustable tether assembly 28 is also composed of a tether rod 62, attached to leg 76 via brackets 78 and 80. Brackets 78 and 80 hold tether rod 62 on roller frame 64 while at the same time keeping tether rod 62 spaced apart from leg 76. This allows quick link 60 (see FIGS. 3 and 4) to couple to tether rod 62 and be movable there along between brackets 78 and 80.

Adjustable stop blocks 82 and 84 are spaced apart from each other and secured to tether rod 62. Illustratively, tether rod 62 extends through adjustable stop blocks 82 and 84. Separate setscrews 86 may, illustratively, each be disposed through adjustable stop blocks 82 and 84, respectively, to engage tether rod 62 and secure the respective stop blocks thereto. Thus, when setscrew 86, on adjustable stop block 82, is loosened, it can be moved in direction 24 or 26, as needed. The setscrew 86 can then be re-tightened against tether rod 62 to secure adjustable stop block 82 thereto. The same operation can be applied to adjustable stop block 84. The span of tether rod 62 between adjustable stop blocks 82 and 84 is the distance tether 32 can move along tether rod 62 in either direction 24 and 26 while adjustable truck bed cargo tray assembly 12 is being moved in those directions as well. Reducing or expanding this span, as well as adjusting the location of the span either more forward in direction 26 or rearward in direction 24, defines the extent of movement of tray 21. In other words, adjusting the positioning and span of adjustable stop blocks 82 and 84 determines the extent to which adjustable tether assembly 30 will guide tray 21 in directions 24 and 26 (see, also, FIGS. 10-14 and 20-21). It is appreciated that other stop structures can be employed as well to dictate and limit the path of travel of the tethers.

The perspective view of adjustable roller frame assembly 36 in FIG. 6 demonstrates how adjustable roller frame assembly 36 is similar to adjustable roller frame assemblies 14 and 16. What is omitted in adjustable roller frame assembly 36 is either adjustable tether assemblies 28 or 30, as well as the forward most wheel 56 attached to roller frame 65. Instead, pivotally attached to the front end of roller frame 65 of adjustable roller frame assembly 36 is a tray retraction stop assembly 88 with wheels 90 and 92. Tray retraction stop assembly 88 is pivotally attached to the front end of adjustable roller frame assembly 36 so that while adjustable truck bed cargo tray assembly 12 is recessed into cargo box 2, wheels 90 and 92 operate to move tray 21 similar to wheels 56 on adjustable roller frame assemblies 14 and 16. Adjustable roller frame assembly 36 also includes a roller frame 66 with the same J-type nut retainers 68 and holes 72. Roller frame 65 of adjustable roller frame assembly 36 includes many of the same structures as roller frame 64 of adjustable roller frame assemblies 14 and 16 for purposes of attaching to and supporting tray 21. Once tray 21 has extended beyond the end of lowered tailgate 6, however, gravity pivots tray retraction stop assembly 88 downward preventing tray 21 from retracting in direction 24 until tray retraction stop assembly 88 is pivoted back up to clear tailgate 6 (see FIGS. 15-18).

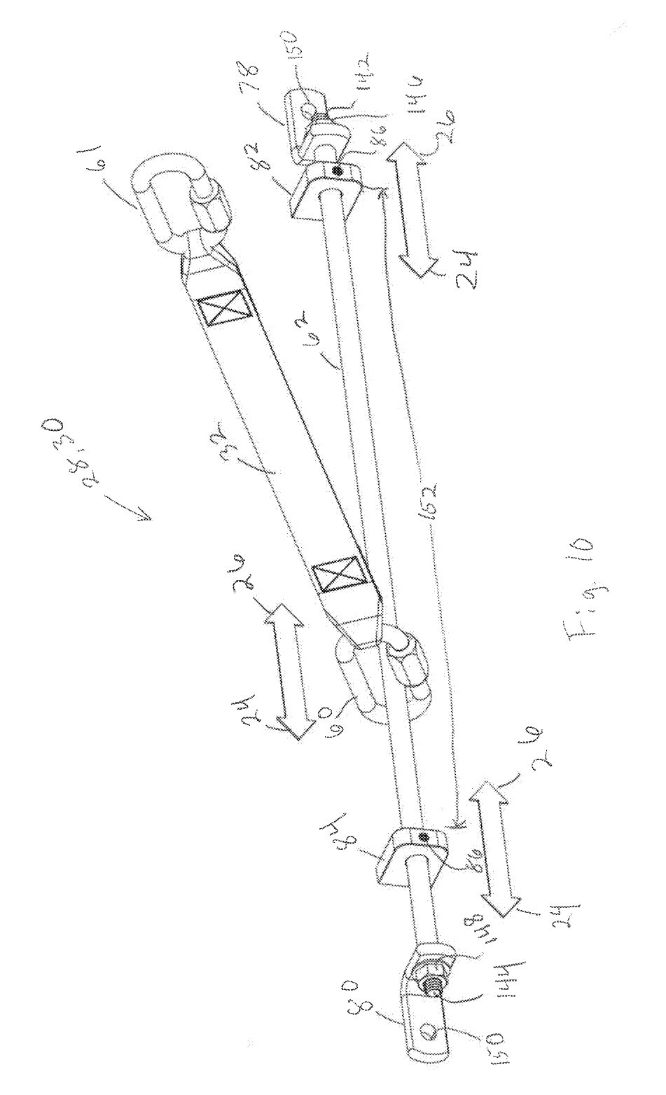

A perspective exploded view of roller frame 64, of either adjustable roller frame assemblies 14 and 16, is shown in FIG. 7. This view depicts the several components that attach to roller frame 64. J-type nut retainers 68, typically made of a spring steel, include a threaded nut that fits into opening 94 disposed through web 70 of roller frame 64. Illustratively, J-type nut retainers 68 are configured to clip onto opening 94, which may illustratively be a square or rectangular opening (see, also, FIGS. 24-25). A threaded nut is attached to J-type nut retainer 68 for purposes of receiving fastener 54, which extends through tray 21 for securing same to roller frame 64 at web 70. As shown in this view, a plurality of illustratively square or rectangular openings 94 are periodically placed on web 70 and each receive a J-type nut retainer 68 to provide securement to tray 21. Illustratively, in some embodiments located adjacent opening 94 may be a bore 96 configured to receive a portion of the threaded nut on J-type nut retainer 68. It is appreciated that although the profiles of opening 94 and/or bore 96 are square/rectangular and circular, respectively, based on the type of securement structure employed to attach tray 21 to roller frame 64, the openings and bores may be of different configuration. It will be further appreciated by the skilled artisan upon reading this disclosure that openings 94 and bores 96 can be of a standard attachment arrangement with J-type nut retainer 68 or other like fastening structure on all of adjustable roller frame assemblies 14, 16, and 36.

Also shown in FIG. 7 are wheels 56 that are periodically spaced along roller frame 64 and attached thereto at extending tabs 98 via bores 100 formed on and disposed through legs 74 and 76 spaced apart via web 70 on roller frame 64. Each wheel 56 fits into channel 104 formed between legs 74 and 76 and are secured thereto via axle pin 102 that is disposed through bushings 106 and wheel 56, as well as bores 100 on legs 74 and 76, respectively. Having wheels 56 located inside channel 104 help protect wheels 56. It is appreciated that on one end of axle pin 102 is a head 108 sized larger than bore 100. The foot of axle pin 102 may be configured to receive a toothed push nut 110 to rotativity secure wheel 56 to roller frame 64. It is appreciated that other similar type lock washers that can secure axle pin 102 to roller frame 64 may be used as an alternative so long as wheel 56 is allowed to rotate relative thereto. These same structures apply to roller frame 65 of adjustable roller frame assembly 36 as well.

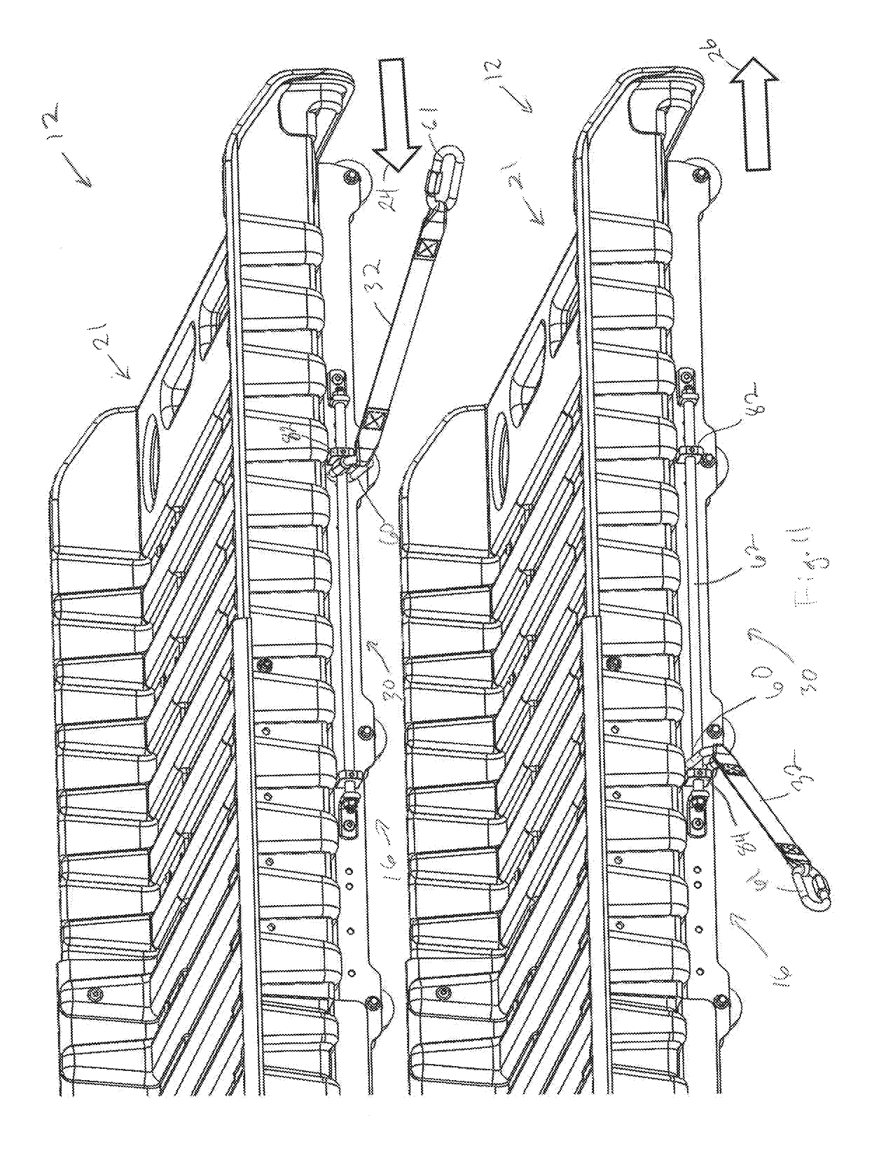

A perspective view of roller frame 66 configured to fit onto a portion of roller frame 64 (as well as roller frame 65) is shown in FIG. 8. Roller frame 66 includes depending legs 112 and 114 separated by web 71 forming channel 116 therebetween. Wheel 56, with bushings 106, receive axle pin 102 and are rotatably secured in place within channel 116 by push nut 110. This provides an additional rolling feature of adjustable roller frame assembly 36. Axle pin 102 is disposed through bore 118 located on tab 120 of each of legs 112 and 114, similar to bore 100 and tab 98 located on each of legs 74 and 76 of roller frame 64 (as well as roller frame 65). J-type nut retainers 68 fit in corresponding openings 94 and bores 96 disposed through web 71, the same as those disposed through web 70 of roller frame 64. Like roller frame 64, roller frame 66 is also attachable to tray 21. Roller frame 66 may, therefore, be movable along and with respect to roller frame 64 to increase or decrease the length of adjustable roller frame assemblies 14, 16 and 36 as needed. Because tray 21 may be composed of a front tray portion that is movable with respect to a rear tray portion like that disclosed in US Patent Application No. 18/381286, titled “Adjustable Bedslide Deck,” adjustable roller frame assemblies 14, 16, and 36 must likewise be adjustable. Again, the adjustability of tray portions create a larger or smaller tray 21 depending and the size of the cargo box. This allows adjustable truck bed cargo tray assembly 12 to be fitted into cargo boxes of a variety of sizes. In other words, adjustable roller frame assemblies 14, 16, and 36 can increase or decrease in length to coincide with the increase or decrease length of tray 21 as needed. Thus, roller frame 66 is movable in either directions 24 or 26, as needed, to extend or retract the length of the roller frame assembly. To that end, through holes 72 are periodically spaced along web 71 of roller frame 66 and coincide with openings 94 and J-type nut retainer 68 of web 70 of roller frame 64 (and roller frame 65). One or more holes 72 can receive fastener 54 (see FIG. 4) which extends therethrough and secures to one or more corresponding J-type nut retainers 68 to secure adjustable roller frame assemblies 14, 16 and 36 to tray 21. Sliding roller frame 66 in direction 26, for example, will decrease the length of the adjustable frame assembly, whereas extending roller frame 66 with respect to roller frame 64 (and roller frame 65), in direction 24, will lengthen the adjustable roller frame assembly. Rear wheel 56 of roller frame 66 adds roller support to the far end of adjustable roller frame assemblies 14, 16 and 36.

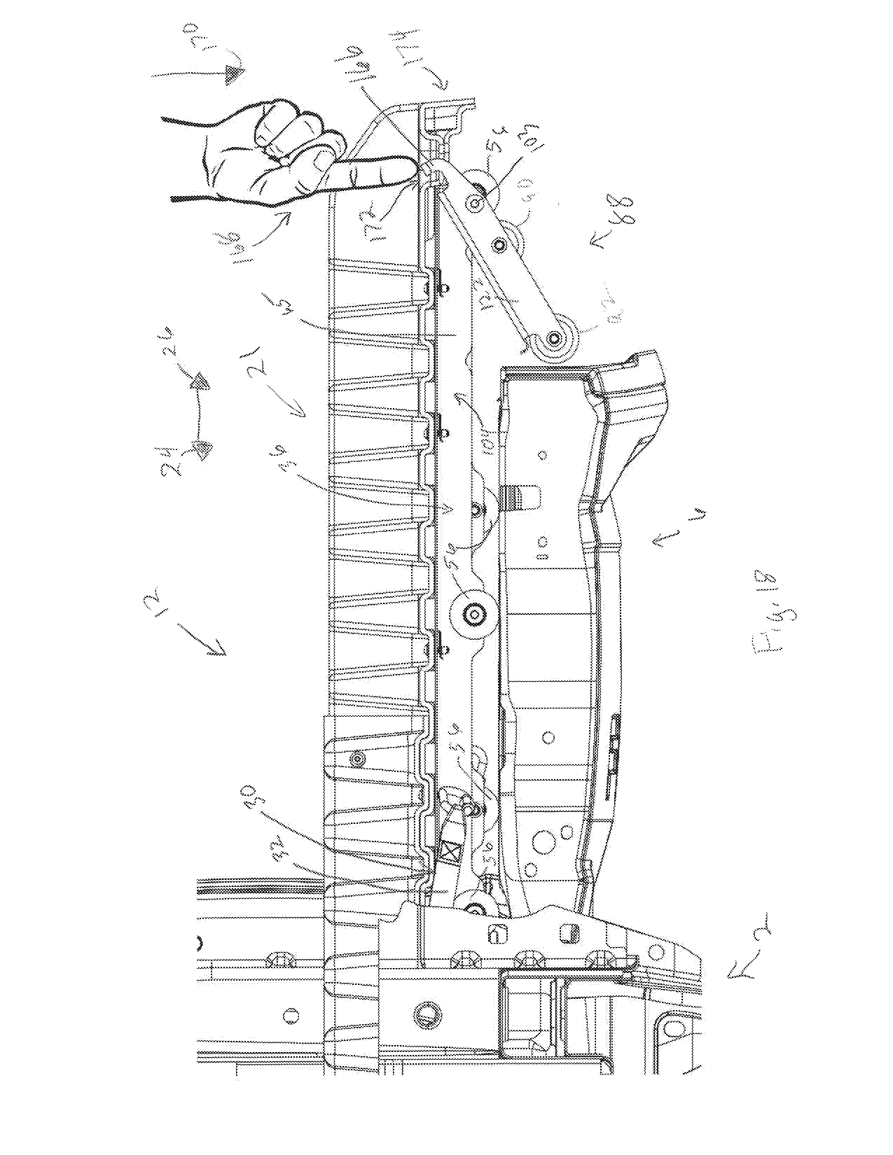

A perspective exploded view of tray retraction stop assembly 88 is shown in FIG. 9. Tray retraction stop assembly 88 is configured to fit at the front end of roller frame 65 as shown in FIG. 6. Tray retraction stop assembly 88 includes a stop frame 122 illustratively composed of a web 124 and legs 126 and 128 spaced apart and extending from web 124. Wheels 90 and 92 may illustratively be similar to wheels 56 and attach to stop frame 122 via similar axle pins 102, bushings 106, and push nut 110. Wheel 90 can be placed within channel 130 and rotatably secured to stop frame 122 by axle pin 102 extending through bore 132, which extend through legs 126 and 128, respectively. Wheel 92 is, likewise, rotatably secured to stop frame 122 via similar axle pin 102, bushings 106, and push nut 110. However, wheel 92 extends from an end 134 of stop frame 122. This allows at least a portion of wheel 92 to extend and be exposed from stop frame 122 to serve, not as only a stop surface, but also as a non-marring stop surface (see FIGS. 17 and 18) when tray retraction stop assembly 88 engages tailgates 6. Also shown in this view is tab 135 extending upward from web 124. Tab 135 helps align stop frame 122 within roller frame 65 so wheels 90 and 92 align with wheels 56.

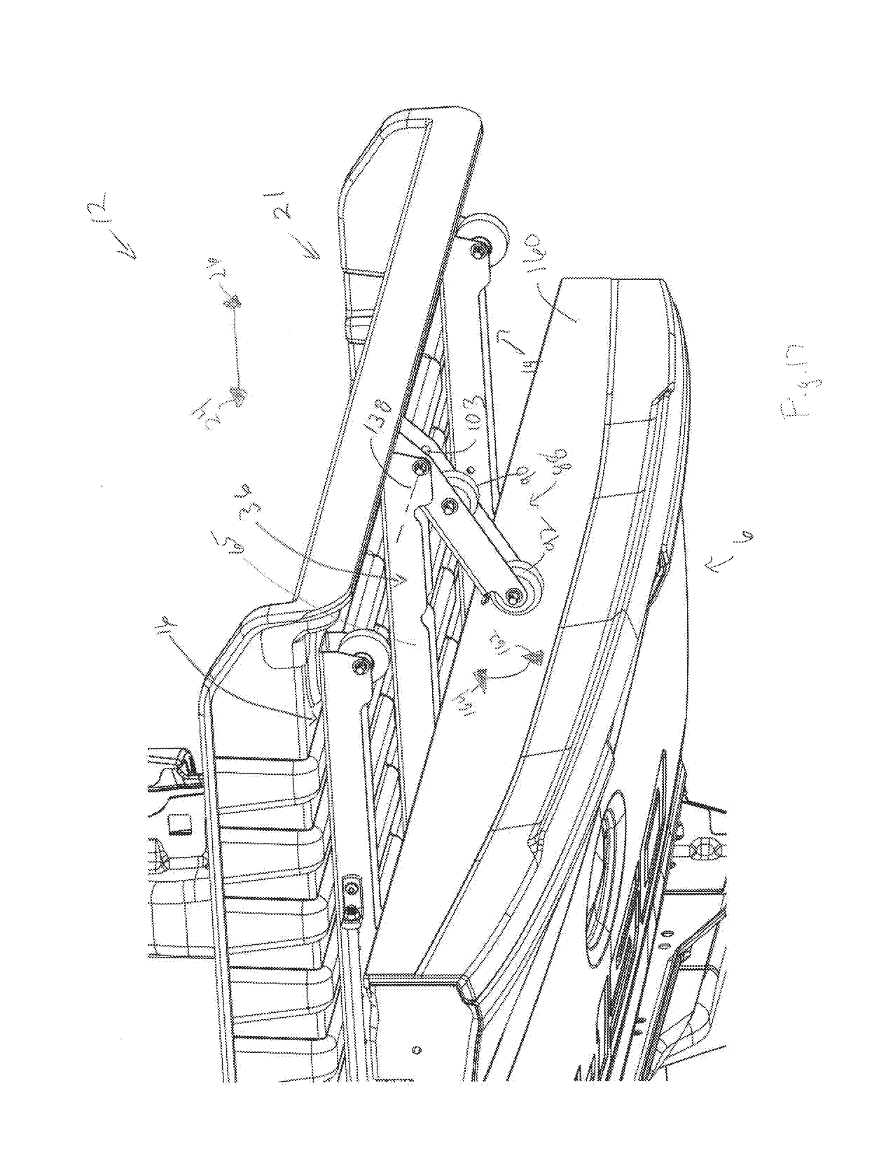

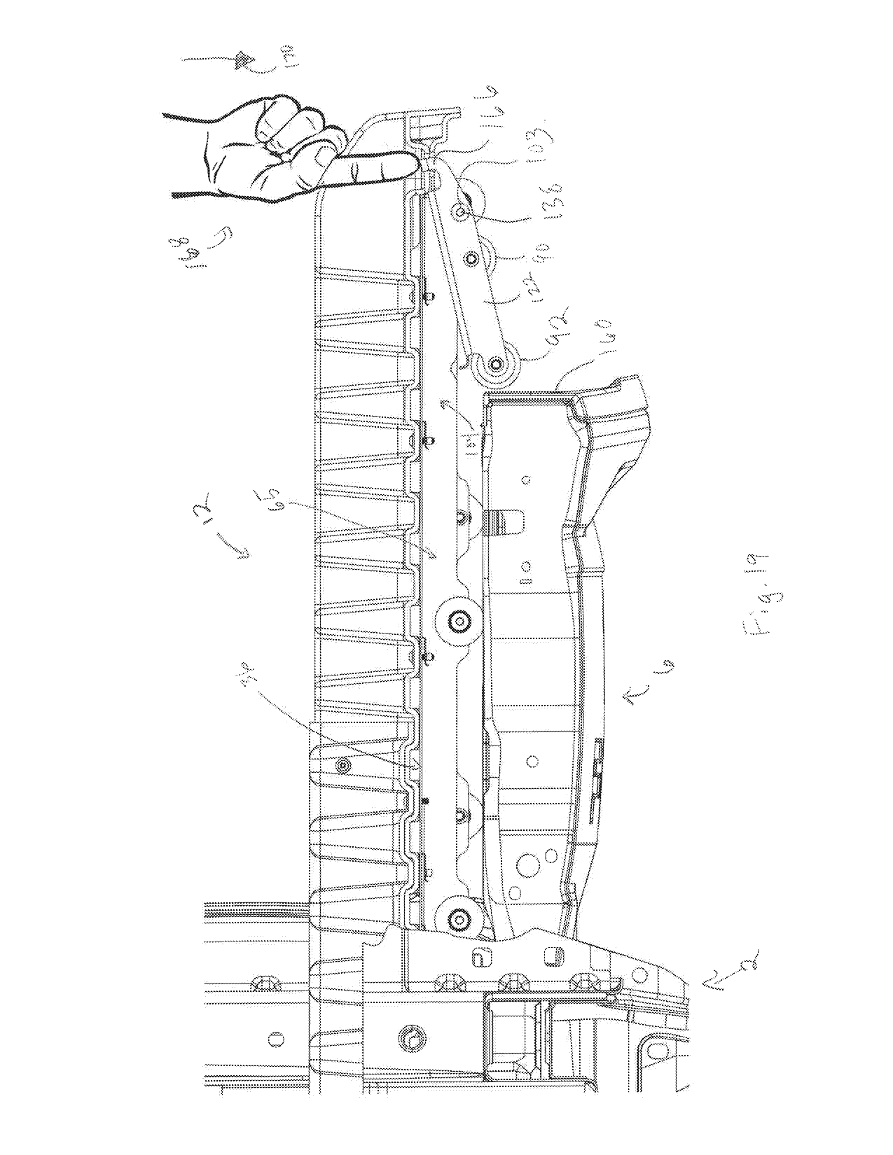

Stop frame 122 also includes a pivot handle 136 illustratively located opposite end 134. When adjustable truck bed cargo tray assembly 2 is extended from tailgate 6 a predetermined amount, tray retraction stop assembly 88 will no longer be supported by same and will fall downward on pivot axis 138 as shown in FIGS. 16 and 17, to prevent tray 21 from retracting back into cargo box 2 unless desired to do so by an operator. Bore 140 disposed through both legs 126 and 128 receives axle pin 103 upon which tray retraction stop assembly 88 pivots with wheel 92 at the far end to engage tailgate 6. Pressure can be exerted onto pivot handle 136, as shown in FIGS. 15-18, to pivot stop frame 122 upward so that wheels 90 and 92 can clear the end of tailgate 6, allowing tray 21 to be rolled back in direction 24 and into cargo box 2 (see, also, FIGS. 18-19).

An isolated detail perspective view of adjustable tether assembly 28 and 30 is shown in FIG. 10. An adjustable tether assembly is located on each side of adjustable truck bed cargo tray assembly 12 to provide balanced guidance while tray 21 is located on the tailgate, as well as assist in securing same within cargo box 2, while tailgate 6 is pivoted upward in its latched condition. It is, therefore, appreciated that adjustable tether assembly 28 can be the same as adjustable tether assembly 30, just located on the opposite side of the adjustable truck bed cargo tray assembly 12 (see, also, FIG. 3). In particular, adjustable tether assembly 28 may be attached to adjustable roller frame assembly 14 while adjustable tether assembly 30 may be attached to adjustable roller frame assembly 16. Otherwise, the structures and features are the same and can be discussed interchangeably. An example of adjustable tether assembly 28 and 30 can be seen attached to corresponding adjustable roller frame assemblies 14 and 16 in FIG. 3.

Each of adjustable tether assemblies 28 and 30 includes adjustable tether rod 62 coupled to brackets 78 and 80 via threaded ends 142 and 144 and secured thereon with illustrative nuts 146 and 148. Brackets 78 and 80 each include illustrative through holes 150, respectively, to receive a fastener that secures brackets 78 and 80 to the outer leg such as leg 74 of roller frame 64 of adjustable roller frame assembly 16 (see FIG. 5) or to leg 76 of roller frame 64 of adjustable roller frame assembly 14. Brackets 78 and 80 are illustrative angle brackets that keep tether rod 62 spaced apart from the leg portion of its corresponding roller frame. This allows quick link 60 to be freely movable in directions 24 and 26 along tether rod 62 between adjustable stop block 82 and 84. To that end, each of adjustable stop blocks 82 and 84 includes a setscrew 86 disposed therethrough, respectively, for purposes of selectively securing each of adjustable stop block 82 and 84 to any desired positions along tether rod 62. The spaced apart locations of adjustable stop blocks 82 and 84 as illustratively shown herein create a span 152 within which quick link 60 and, ultimately, tether 32, can travel. Adjustable stop blocks 82 and 84 can each be moved independently along tether rod 62 in order to expand or reduce span 152 as necessary to ensure that tray 21 can extend into and retract from cargo box.

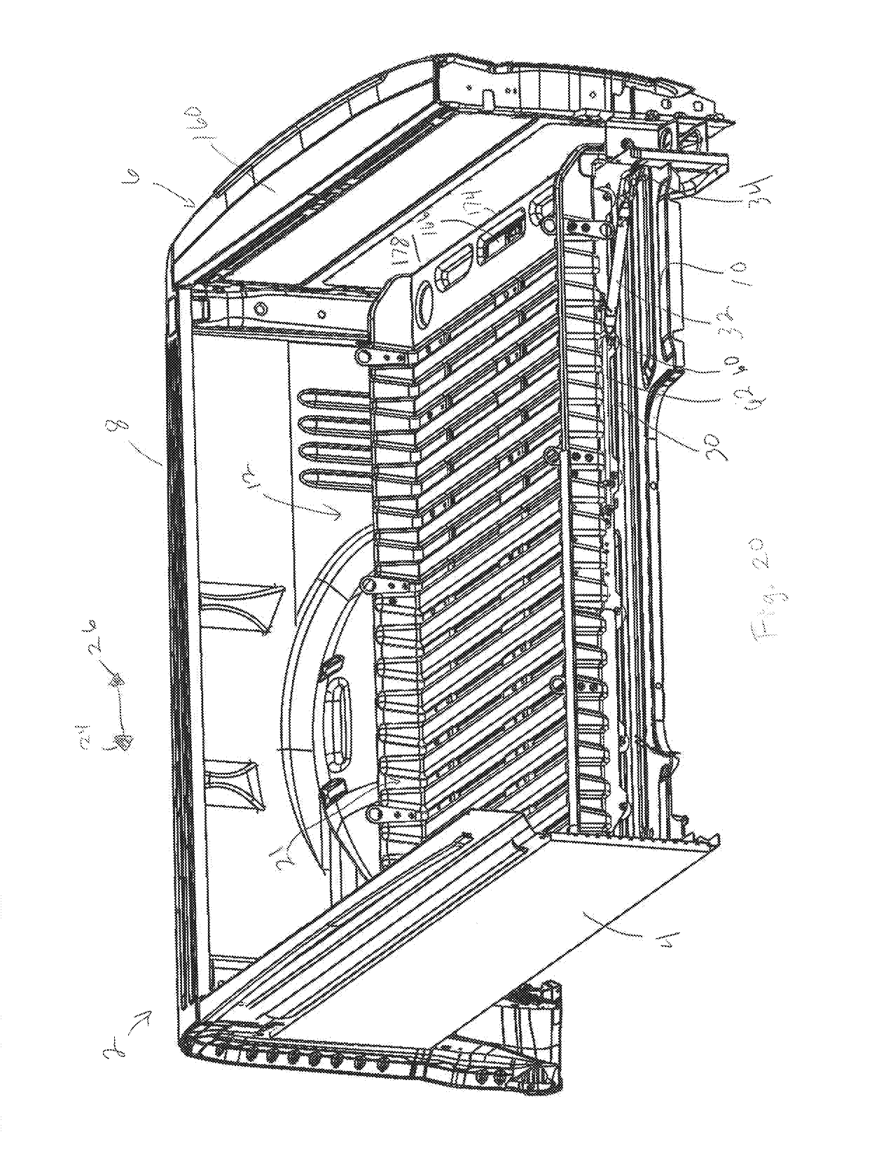

Because pickup truck cargo boxes come in different lengths, the length of travel available to adjustable truck bed cargo tray assembly 12 depends on the truck bed’s length. For example, a larger cargo box can have a greater span of travel for tether 32 (and hence adjustable truck bed cargo tray assembly 12) than a smaller cargo box. In the former case, a greater span 152 will be made along tether rod 62 than the former truck bed length. To create a greater span, for example, setscrew 86 of adjustable stop block 82 can be loosened and adjustable stop block 82 moved in direction 26. Setscrew 86 can then be retightened to lock adjustable stop block 82 in place along tether rod 62. Additionally, setscrew 86 of adjustable stop block 84 can be loosened and adjustable stop block 84 moved in direction 24 opposite of the direction 26 moved by adjustable stop block 82. Setscrew 86 can then be retightened to lock adjustable stop block 84 into place. The effect of this is that span 152 is made longer. For cargo boxes of relatively shorter length, adjustable stop blocks 82 and 84 can be moved in opposite directions to reduce the length of span 152. This means tether 32 movably coupled to tether rod 62, via illustrative quick link 60, will travel a shorter distance. This is useful not only to guide tray 21 to a predetermined extension on tailgate 6 (affected by positioning of adjustable stop block 82), but will also place tray 21 in a predetermined stowed position (affected by the position of adjustable stop block 84). This can include leading edge 174 of tray 21 abutting against tailgate 6 while in its upright, latched position (see FIGS. 20-21). This can also prevent tray 21 from rolling back and forth within cargo box 2 while the pickup truck is in motion. Further, it ensures leading edge 174 of tray 21 is adjacent tailgate 6 so as to be available for use by the operator when tailgate 6 is opened. There is no need to reach far into cargo box 2 to grab tray 21 and extend it from tailgate 6 in direction 26.

Also shown in this view is another quick link 61 attached to tether 32 opposite from quick link 60. Quick link 61 is configured to attach to a conventional tiedown point (such as tiedown 34 as shown in FIG. 1) at the rear of cargo box 2. This assists guiding tray 21 over the tailgate and limiting the extent to which tray 21 can extend from cargo box 2.

Contrasting detail perspective views of tray 21 of adjustable truck bed cargo tray assembly 12, moved in direction 24 versus direction 26, are shown in FIG. 11. As demonstrated when tray 21 is moved in direction 24, tether 32, which will be attached to the hold down point via quick link 61 (see FIG. 1) and quick link 60 engaging adjustable stop block 82 of adjustable tether assembly 30, limits the extent of rearward travel. Even though adjustable roller frame assemblies 14, 16, and 36 allow tray 21 to move back and forth along cargo box floor 10 of cargo box 2, that movement is guided and limited by adjustable tether assemblies 28 and 30 on each side of adjustable truck bed cargo tray assembly 12, including while over tailgate 6.

This view demonstrates how the location of adjustable stop block 82, on tether rod 62, dictates the furthest extent rearward adjustable truck bed cargo tray assembly 12 can move in direction 24. It will be appreciated by the skilled artisan upon reading this disclosure that such adjustability allows tray 21 to fit and move into and out of cargo box 2 based on the size of cargo box 2. Some cargo boxes may be configured so adjustable stop block 82 needs to be moved further in direction 26 along tether rod 62 so tray 21 fits into cargo box 2 when retracted. Other cargo box configurations may require adjustable stop block 82 to be moved further in direction 24 along tether rod 62 in order to accomplish the same thing. In either instance, however, the same adjustable truck bed cargo tray assembly 12, with adjustable tether assemblies 28 and 30, can be employed in any such variety of cargo boxes.

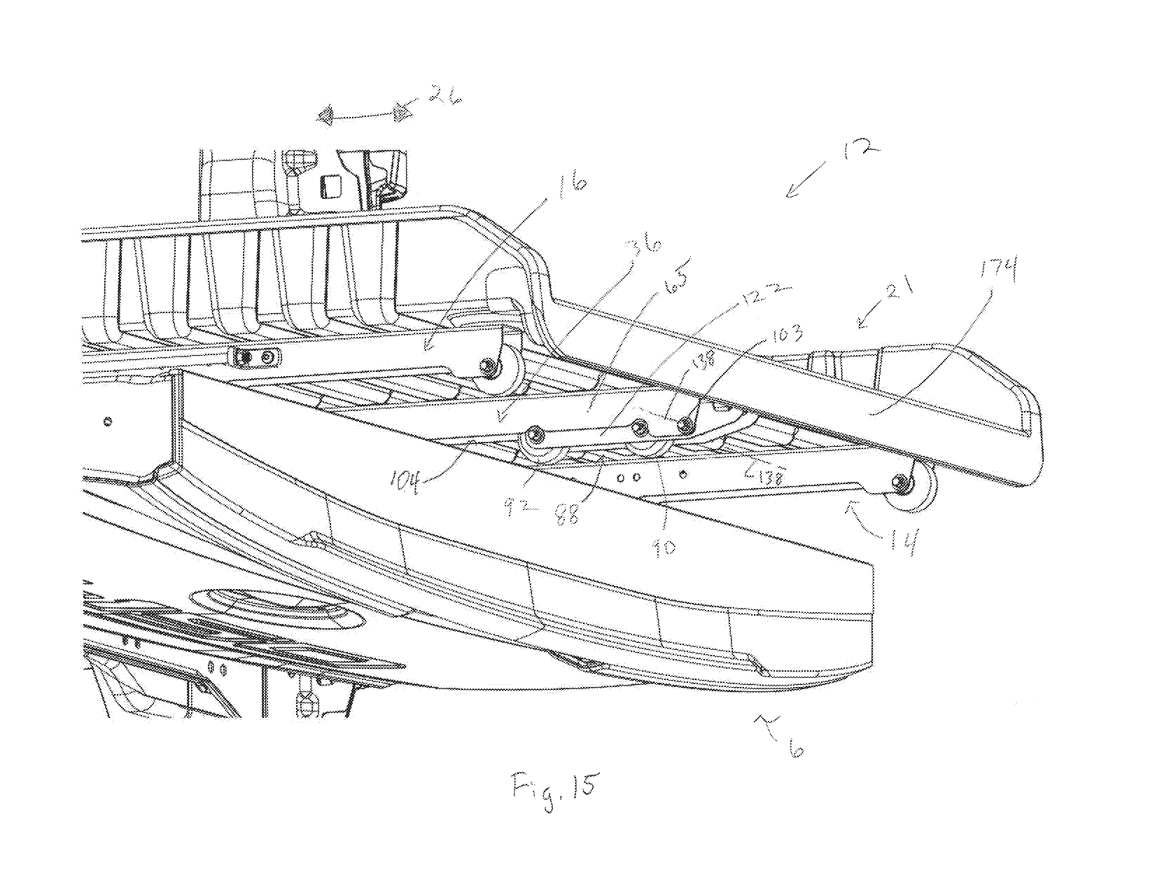

Similarly, as also shown and FIG. 11, with tray 21 moved further in the opposite direction, i.e., direction 26, tether 32 is pulled forward in direction 26, as well as over tailgate 6 (see FIG. 14), such that quick link 60 engages adjustable stop block 84 located on tether rod 62 spaced apart from adjustable stop block 82. This connotes the furthest extent tray 21 can extend from this particular configuration of cargo box 2. The full extent of travel in directions 24 and 26, as shown in this view, are defined by span 152 between adjustable stop blocks 82 and 84 (see FIG. 10). It is appreciated that span 152 can be shifted, widened, and/or narrowed as needed to ensure tray 21 extends into or out of cargo box 2 as described herein or even as desired by the operator of the pickup truck.

A perspective detail view of a portion of adjustable truck bed cargo tray assembly 12, moveably coupled to cargo box 2 shown in detail cutaway form, is shown in FIG. 12. Here, adjustable roller frame assembly 16 (as well as adjustable roller frames 14 and 36 not shown in this view) moves tray 21 along cargo box floor 10 of cargo box 2 on wheels 56 (as well as wheels 90 and 92). Also shown herein is quick link 61 attached to tiedown 34 of cargo box 2. Such tiedowns are typically located on the sidewall or other structure adjacent the tailgate on each side of the cargo box. If such structure is not a standard feature of the cargo box, such tiedowns in the form of loops or hooks can be affixed to the cargo box to give quick links 61 of adjustable tether assemblies 28 and 30 points of attachment to cargo box 2. Such standard tiedowns or other suitable attaching structures are features believed to be known to persons of ordinary skill in the art. This view also shows quick links 60 abutting adjustable stop block 82 defining the rearward-most extent adjustable truck bed cargo tray assembly 12 can retract in direction 24 into cargo box 2. It is appreciated that the structures of adjustable tether assembly 30 attached to adjustable roller frame assembly 16 and to cargo box 2 are substantively the same as the structures and operation of adjustable tether assembly 28 attached to adjustable roller frame assembly 14 on the opposite side of cargo box 2 and tray 21.

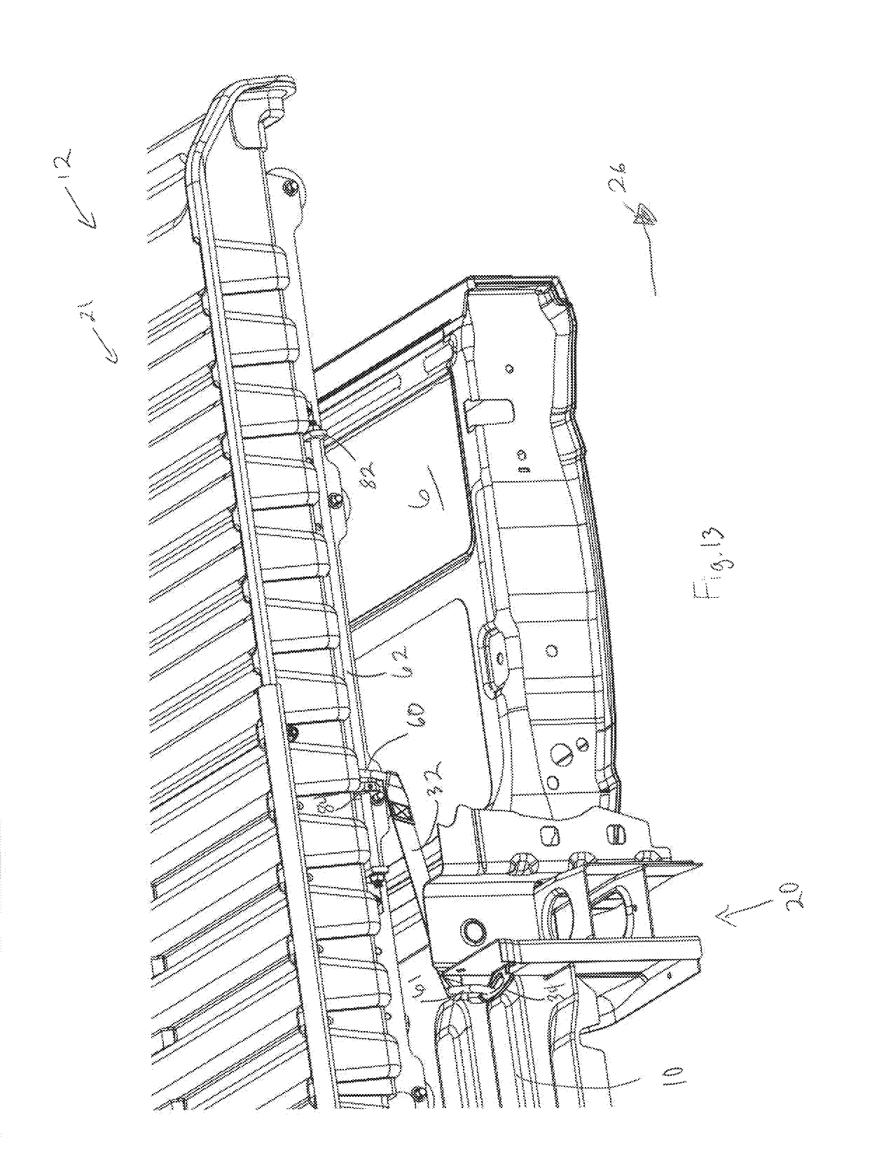

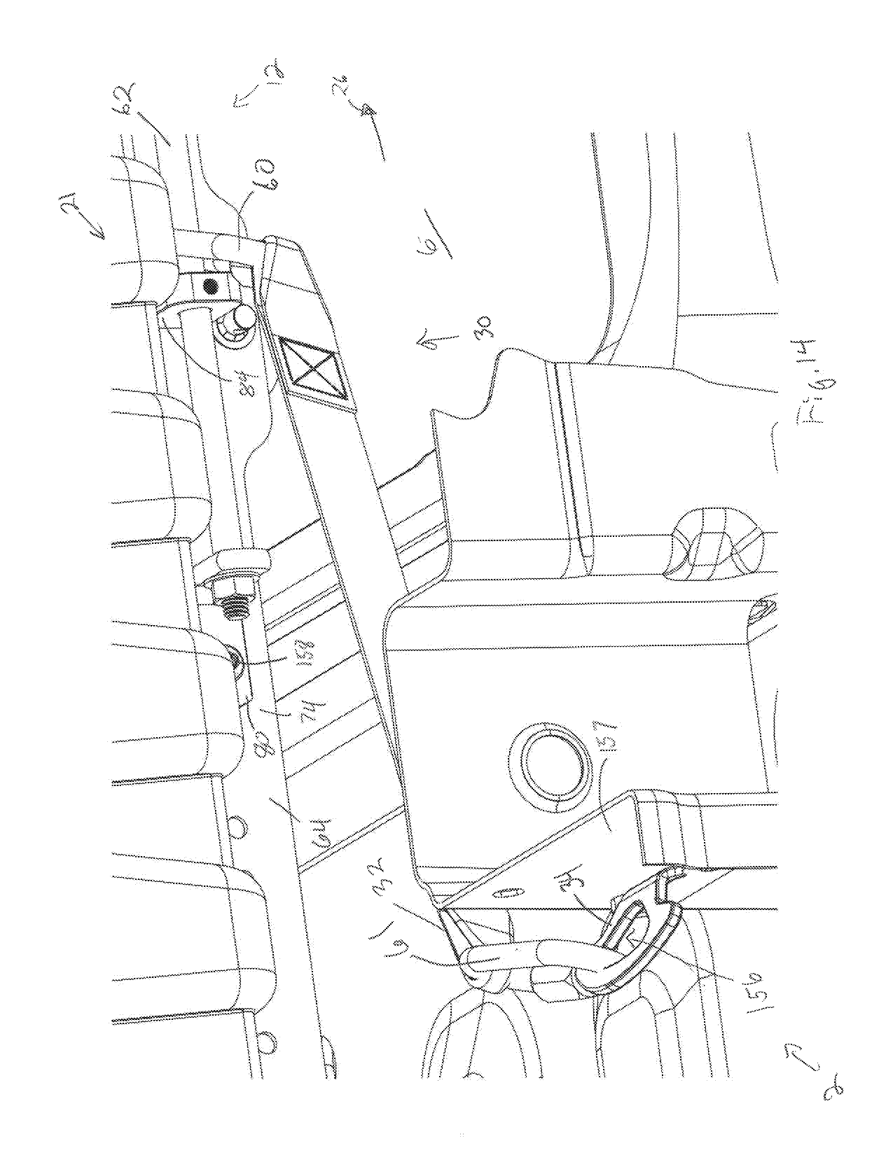

Another perspective detail view of tray 21, of adjustable truck bed cargo tray assembly 12 located on cargo box floor 10 of cargo box 2, are shown in the partial detail view of FIG. 13. This view, in contrast to that of FIG. 12, depicts tray 21 extending in direction 26 over tailgate 6. This view further demonstrates how quick link 61, attached to tiedown 34, holds on to tether 32, which extends out of cargo box 2 and over tailgate 6 until quick link 60, moveably coupled to tether rod 62, abuts adjustable stop block 84 located distal adjustable stop block 82. Extending adjustable tether assembly 30 out over tailgate 6 helps keep tray 21 over tailgate 6, as well as limiting the extent of travel of tray 21. Accordingly, as depicted in FIGS. 11-13, the skilled artisan will appreciate how adjustable tether assemblies 28 and 30 limits the scope of travel of tray 21 from inside cargo box 2 to outside same and over tailgate 6.

Another perspective detail view of adjustable truck bed cargo tray assembly 12 and, particularly, how tray 21 can be limited in its extent of travel over tailgate 6, is shown in FIG. 14. Here, tiedown 34 is shown attached to wall 157 of cargo box 2. Again, such tiedowns are believed known to those of ordinary skill in the art as common features to pickup truck cargo boxes. This view also shows quick link 61 fitted through loop 156 of tiedown 34. Quick link 61 is also attached to tether 32, which is likewise attached to quick link 60 moveably fitted on adjustable tether rod 62.

This view further demonstrates how adjustable tether assembly 30 is limited in travel in direction 26 by virtue of the placement of adjustable stop block 84 on tether rod 62. It is further appreciated by this view how adjustable tether assembly 30 is attached to roller frame 64, underneath tray 21, via bracket 80, with fastener 158 disposed through hole 150 (see FIG. 10) and secured to leg 74. It is understood that such structures and attachment means described herein with respect to adjustable tether assembly 30 is substantively the same with respect to adjustable tether assembly 28 located on the other side of adjustable truck bed cargo tray assembly 12 on adjustable roller frame assembly 14.

An underside detail view of a portion of adjustable truck bed cargo tray assembly 12 extending over tailgate 6 is shown in FIG. 15. Tray 21 is supported by adjustable roller frame assemblies 16, 14, and 36. As shown, adjustable truck bed cargo tray assembly 12 is configured to at least partially extend from tailgate 6 when moved in direction 26. The length of adjustable roller frame assemblies 14, 16, and 36 having a plurality of rollers attached thereon (see, also, FIGS. 5 and 6) provide support for tray 21 at its rear while the front end portion is suspended from tailgate 6. This view also depicts tray retraction stop assembly 88.

The view in FIG. 15, along with the views in FIGS. 16-19 demonstrate the operation of tray retraction stop assembly 88. As shown in FIG. 15, particularly, tray retraction stop assembly 88 is located in its recessed condition with stop frame 122 and wheels 90 and 92 retracted within channel 104 of roller frame 65 (see, also, FIGS. 6, 7, and 8). While tray 21 is rolling on cargo box floor 10, tray retraction stop assembly 88 is pivoted upward at pivoted axis 138 formed by axle pin 103, which allows stop frame 122 to be recessed in channel 104 of roller frame 65. In this position, tray retraction stop assembly 88 can serve to support tray 21 with wheels 90 and 92 the same as the other adjustable roller frame assemblies 14 and 16 with their wheels 56 for moving tray 21 in either directions 24 or 26.

A similar detail perspective view of adjustable truck bed cargo tray assembly 12, extending from tailgate 6, like that shown FIG. 15, is shown in FIGS. 16 and 17. The view in FIG. 16 differs from that of FIG. 15 in that tray 21 has been pulled out far enough in direction 26 to have fully cleared end surface 160 of tailgate 6. This allows stop frame 122 with wheels 90 and 92 to pivot downward in direction 162 at pivot axis 138 on axle pin 103. This pivot motion in direction 162 drops wheel 92 so that it is located adjacent end surface 160 of tailgate 6.

The view in FIG. 17 shows tray retraction stop assembly 88 fully pivoted downward in direction 162 adjacent end surface 160. This creates an obstacle for adjustable truck bed cargo tray assembly 12 so that if tray 21 is attempted to be pushed back in direction 24 and into cargo box 2, tray retraction stop assembly 88 via its attachment to adjustable roller frame assembly 36 fastened to tray 21 prevents same from moving. This means that tray 21, when being used, does not inadvertently retract in direction 24 back and into cargo box 2. For example, if bags of materials such as feed, river rock, or cement (just to name a few) are tossed into cargo box 2 and lands on tray 21, a force is applied to same in direction 24. Being that tray 21 is set on wheels 56, tray 21 may have a propensity to move in direction 24 in response to that force. Tray retraction stop assembly 88 prevents tray 21 from retracting in direction 24 in response to that force. Accordingly, a skilled artisan upon reading this disclosure will recognize that adjustable truck bed cargo tray assembly 12 can be extended from cargo box 2 and beyond tailgate 6 so that a portion of tray retraction stop assembly 88 drops or pivots downward past tailgate 6 in anticipation for loading heavy articles onto tray 21. Those heavy articles can then be placed, tossed, or dropped, for example, onto tray 21. And, even if there is a force exerted on tray 21 by those heavy articles, tray 21 will not move back into cargo box 2 because wheel 92 of tray retraction stop assembly 88 is abutted against end surface 160 of tailgate 6. It is further appreciated that wheel 92 is located at the end of stop frame 122 to abut or engage end surface 160 of tailgate 6 rather than stop frame 122. Because wheel 92 may be made of a silicone, rubber, or other resilient-type material, its abutment against end surface 160 does not mar same.

Illustratively, two wheels 90 and 92 are provided spaced apart along stop frame 122 in order to provide support for tray retraction stop assembly 88 as it is being passed over a seam (not shown) conventionally located between the end of cargo box floor 10 and tailgate 6. As one wheel, such as wheel 92, passes over this seam between cargo box floor 10 and in tailgate 6, wheel 90 supports stop frame 122 so that wheel 92 does not drop down into the seam between cargo box floor 10 and tailgate 6 when adjustable truck bed cargo tray assembly 12 is moving in direction 24 back into cargo box 2. Conversely, wheel 92 can provide support for wheel 90 to keep stop frame 122 from moving downward and allowing wheel 90 to fall into the seam between cargo box floor 10 and tailgate 6 when adjustable truck bed cargo tray assembly 12 is moving in direction 26 out of cargo box 2.

In further embodiments, one wheel, pad, or other abutment structure may be employed in a dual arrangement or singularly to create both that abutment structure against end surface 160 of tailgate 6 while at the same time providing support so tray retraction stop assembly 88 does not fall into the seam between cargo box 2 and tailgate 6 during extension or retraction of tray 21. In other embodiments, a single roller or abutment structure may be used in tray retraction stop assembly 88 in place of wheels 90 to 92, so that stop frame 122 or like structure does fall into the seam between cargo box floor 10 and end tailgate 6. This may serve as an interim stop location to dictate a predetermined position that tray 21 will stop or can be stopped along its path of travel in either directions 24 or 26.

A side detail sectional view of a portion of cargo box 2, with tailgate 6 lowered, and a portion of adjustable truck bed cargo tray assembly 12 extended therefrom, is shown in FIG. 18. The views in FIGS. 18 and 19 demonstrate how tray retraction stop assembly 88 has dropped when extended in direction 26 to prevent retraction and can be disengaged when retracting adjustable truck bed cargo tray assembly 12 as desired. Stop frame 122 includes a lever handle 166 that can be actuated by a hand (or even finger) 168 of an operator by pushing lever handle 166 downward in direction 170. Lever handle 166, is accessible by hand 168 via opening 172 disposed through the front portion of tray 21. Illustratively, lever handle 166 exposed by opening 172 can be positioned adjacent leading edge 174 of tray 21. This allows an operator standing behind tailgate 6 and in front of adjustable truck bed cargo tray assembly 12 to simply press lever handle 166 in direction 170 in order to retract tray retraction stop assembly 88.

The view in FIG. 19, similar to FIG. 18, is a detail side cross-sectional view of cargo box 2, tailgate 6, and adjustable truck bed cargo tray assembly 12. In FIG. 19, however, hand 168 is moved further downward in direction 170 than that shown in FIG. 18 so that hand 168 pushes further down on lever handle 166. Because lever handle 166 is located opposite wheel 92, with pivot axis 138 of axle pin 103 located therebetween, as lever handle 166 moves further downward, wheel 92 moves further upward. As hand 168 continues moving downward in direction 170, wheel 92, as well as stop frame 122, moves further upward into channel 104 of roller frame 65. This continues until wheel 92 clears end surface 160 of tailgate 6. Tray retraction stop assembly 88 is, thus, moved back to its original position within adjustable roller frame assembly 36 as shown in FIG. 15. When in that position, tray retraction stop assembly 88 no longer inhibits movement of tray 21 back in direction 24. This means adjustable truck bed cargo tray assembly 12 is movable back into cargo box 2.

A side perspective partial cutaway view of a portion of cargo box 2, with adjustable truck bed cargo tray assembly 12 located inside on cargo box floor 10, is shown in FIG. 20. This view depicts tailgate 6 positioned upward in its latched condition with respect to sidewall 8 and bulkhead 4. This view demonstrates how tray 21 of adjustable truck bed cargo tray assembly 12 is wedged in cargo box 2 between tailgate 6 and adjustable stop block 82 of adjustable tether assembly 30 (and adjustable tether assembly 28). By wedging tray 21 within cargo box 2, tray 21 will not substantially roll back and forth in directions 24 and 26 while the pickup truck is in motion. Leading edge 174 is shown abutting surface 178 of tailgate 6. Tether 32 coupled to tiedown 34 on cargo box 2 and tether rod 62 at the other end helps hold tray 21 in place. More particularly, quick link 60 extending from tether 32 abuts against adjustable stop block 82 (see FIGS. 12 and 21) while tray 21 is fully retracted in direction 24 inside cargo box 2. It is appreciated that adjustable tether assembly 28 (not shown in this view) includes the same structures and operates in the same way as that described with respect to adjustable tether assembly 30 herein.

A detail perspective partial cut away view of cargo box 2, with tray 21 located therein, and with tailgate 6 upright in its latched condition, is shown in FIG. 21. This detail view further demonstrates how adjustable tether assembly 30 (as well as adjustable tether assembly 28 not shown) holds tray 21 within cargo box 2. Particularly, with tailgate 6 in its upright condition, surface 178 of tailgate 6 abuts leading edge 174 of tray 21 preventing any forward motion of tray 21 in direction 26. Tether 32 being secured to tiedown 34 via quick link 61, while quick link 60 is abutted against adjustable stop block 82, limits movement of tray 21 in direction 24. The net effect is that tray 21 can be held in a relatively stationary position within cargo box 2, while tailgate 6 is upright in its latched condition. It is further appreciated that by adjusting adjustable stop block 82 in either directions 24 or 26 slightly and securing adjustable stop block 82 onto tether rod 62 via setscrew 86, the amount of tension placed on tether 32, when held in place by the abutment of leading edge 174 and surface 176, can be adjusted as desired, likewise, creating a sufficient holding force for tray 21 within cargo box 2. For example, moving adjustable stop block 82 in direction 26 reduces the distance between adjustable stop block 82 and tailgate 6 which can reduce tension on strap 32 when holding tray 21. Conversely, moving adjustable stop block 82 in direction 24 along tether rod 62 and securing adjustable stop block 82 thereon via setscrew 86 increases the distance between adjustable stop block 82 and tailgate 6, which can increase tension on tether 32 while holding tray 21 within cargo box 2. The point being that moving adjustable stop block 82 in either directions 24 or 26 can serve to hold tray 21 within cargo box 2 with an amount of tension desired by the operator.

As discussed with respect to FIGS. 3 and 4, cargo boxes typically include front to rear longitudinally extending ribbed floors. Such ribbed floors allow raised sections to provide underneath access to articles placed on top of the ribs. Between each longitudinally extending rib 40is a longitudinally extending flat 42. For purposes of the present disclosure, such longitudinally extending flats 42 can be employed as tracks for wheels 56, 90, and 92 underneath tray 21 of adjustable truck bed cargo tray assembly 12. Although such alternating ribs 40and flats 42on cargo box floor 10 are common features, each manufacturer designs those ribs and flats a bit differently. These ribs and flats can be sized, spaced apart, or alternated differently from one manufacturer to another. Accordingly, an illustrative embodiment of the present disclosure includes adjustable roller frame assemblies 14, 16, and 36 that are laterally adjustable on tray 21 to accommodate the differently spaced ribs and flats of different pickup truck manufacturer designs.

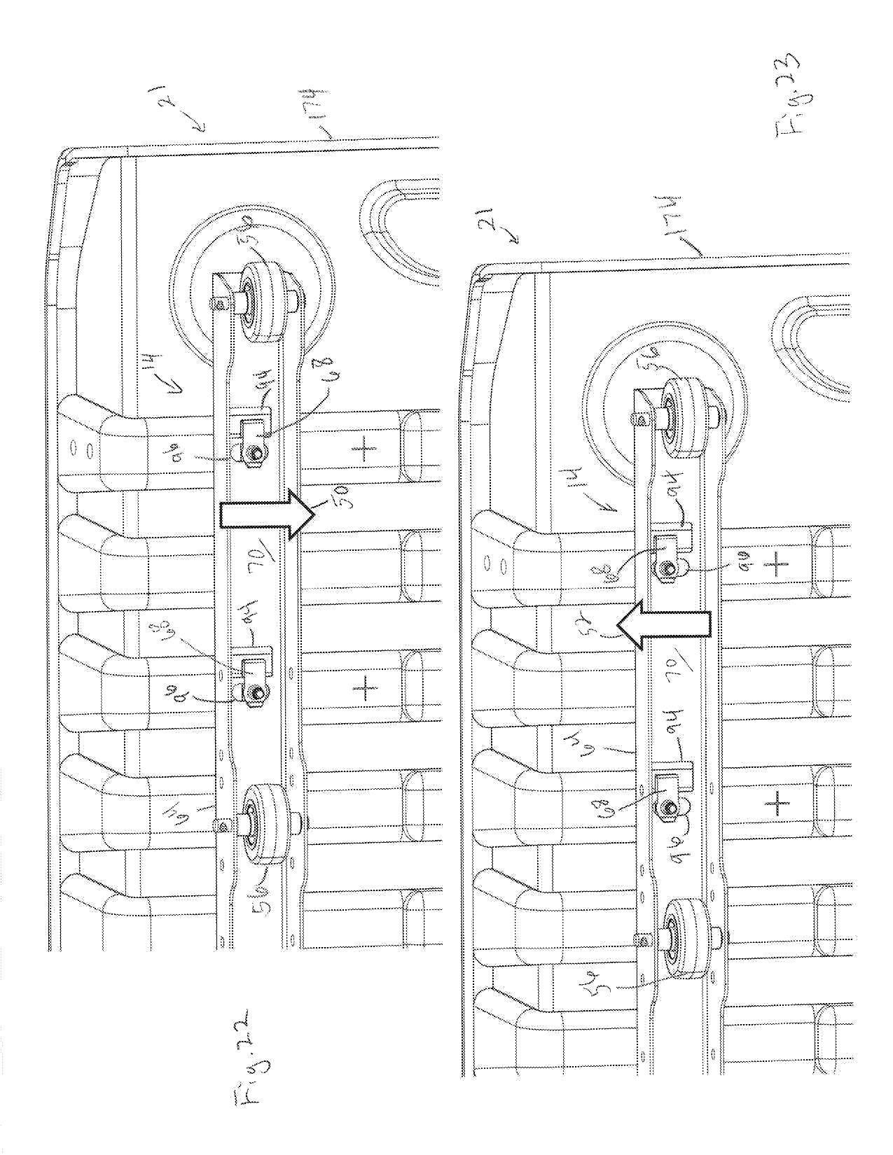

A detail underside view of a portion of adjustable roller frame assembly 14, attached to tray 21, is shown and FIGS. 22 and 23. The difference between these two views are the relative lateral positioning of adjustable roller frame assembly 14 with respect to the underside of tray 21. Adjustable roller frame assembly 14 is moved in direction 50 in FIG. 22 and in the opposite direction 52 in FIG. 23. As first discussed with respect to FIGS. 3 and 4, having adjustable roller frame assembly 14 (as well as adjustable roller frame assemblies 16 and 36) movable in either directions 50 or 52 allows tray 21 to be custom positioned within any particular cargo box 2, particularly, between the wheel wells so the adjustable roller frame assemblies follow the flats, such as flat 42 (see, also, FIGS. 3 and 4), that may be in a different position along the cargo box floor depending on the manufacturer of the pickup truck.

As discussed with respect to FIGS. 5-9, each of adjustable roller frame assemblies 14, 16, and 36 includes a plurality of openings 94 and corresponding bores 96 to accommodate J-type nut retainers. It is appreciated from the views in FIGS. 22 and 23 (see, also, FIGS. 24 and 25) that openings 94 and bore 96 can be slot-shaped, not necessarily square or circular. The J-type nut retainer 68 that fits therein is illustratively smaller so it can move in either directions 50 or 52 within opening 94 and bore 96 so that roller frame 64 may, likewise, be moved in either directions 50 or 52 in order to fit wheels 56 onto a flat, such as flat 42 (see FIGS. 3 and 4). Depending on the location of the flats, roller frame 64 can be moved in direction 50 with respect to J-type nut retainer 68 and tray 21 as shown in FIG. 22. Both opening 94 and bore 96 have a longitudinal expanse or slot so that roller frame 64 can move some distance to the extent necessary to fit rollers 56 onto flat 42 of cargo box floor 10. Conversely, frame 64 can be moved in direction 52 with respect to J-type nut retainer 68 and tray 21 so that wheels 56 can fit onto a flat, which may be located in a different position on the floor of a cargo box of a pickup truck from a different manufacturer. It is appreciated that all three adjustable roller frame assemblies 14, 16, and 36 are independently movable in either directions 50 or 42in order to accommodate differently configured cargo box floor designs from different pickup truck manufacturers.

Perspective end detail views of roller frame 64 of adjustable roller frame assembly 14 are shown in FIGS. 24 and 25. These views demonstrate how J-type nut retainer 68 can be moved within a longitudinal extent 180 of both opening 94 and bore 96 disposed within web 71 of froller rame 64 in order to position adjustable roller frame assembly 14 in desired positions on tray 21. The view in FIG. 24 depicts J-type nut retainers 68 moved in direction 50 within both opening 94 and bore 96 positioning J-type nut retainer 68 further to the left within lateral extent 180. The view in FIG. 25, on the other hand, moves J-type nut retainer 68 further in direction 52 positioning same further to the right within the lateral extent 180 of opening 94 and bore 96. Fastener 54 can then be tightened against tray 21 once adjustable roller tray assembly 14 is positioned as desired to keep same secured and movable along flat 42 on cargo box floor 10.

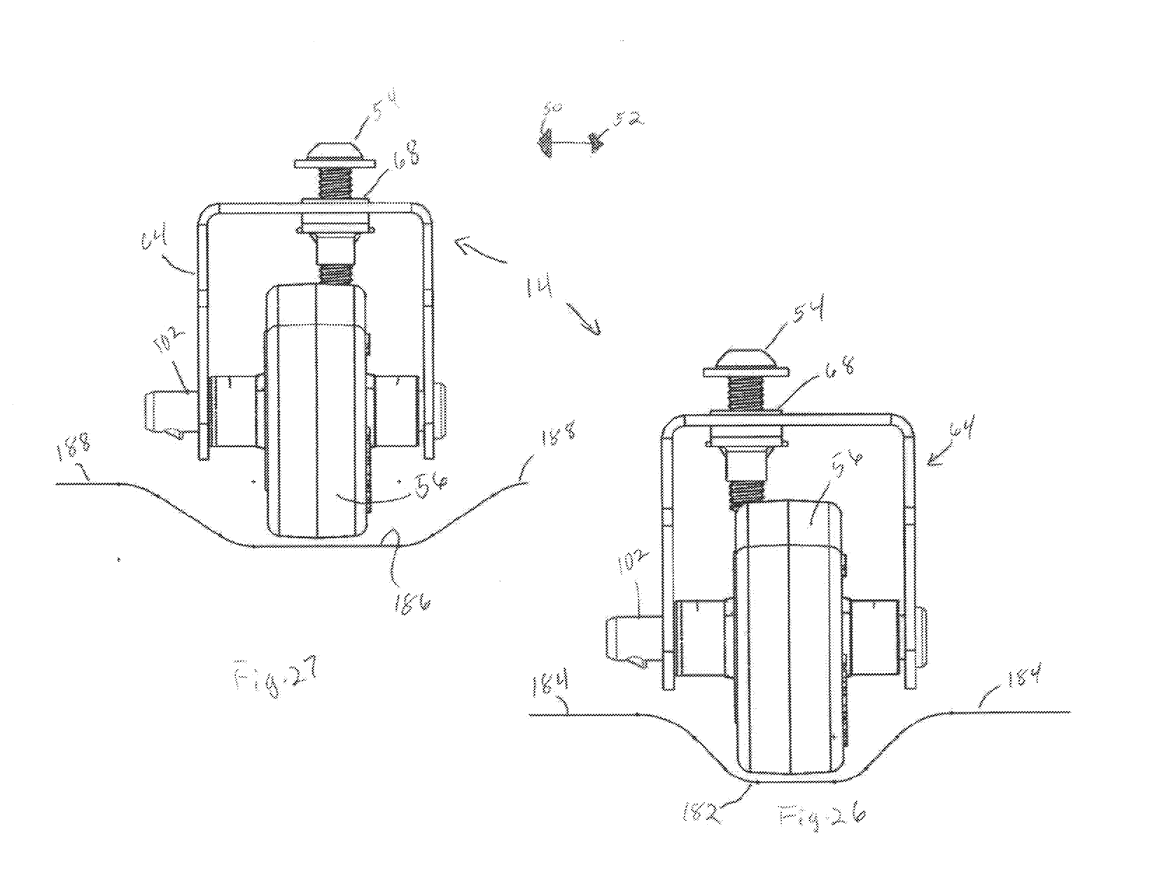

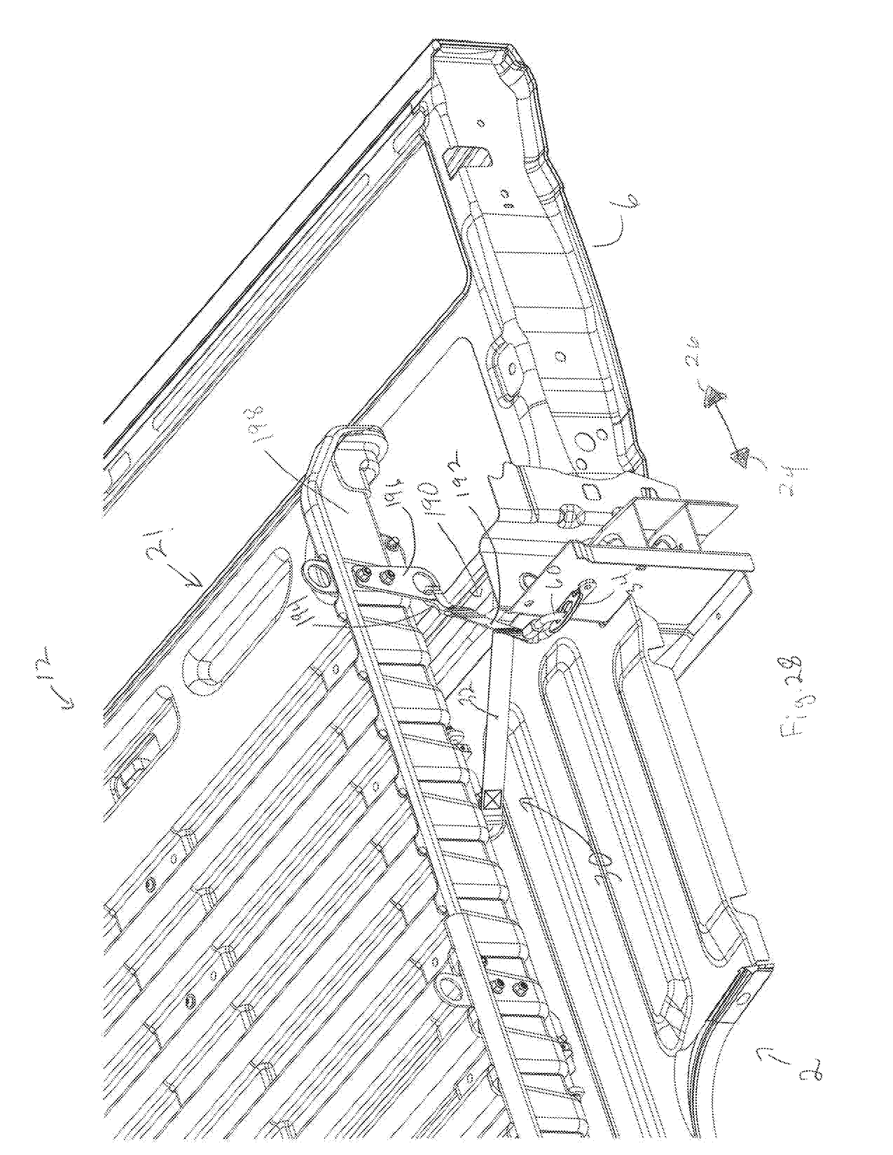

To that end, isolated detail end views of adjustable roller frame assembly 14 are shown in FIGS. 26 and 27. By positioning J-type nut retainer 68 further in direction 50, within opening 94 and bore 96, as shown in FIG. 26, roller frame 64 is moved further into direction 52 so that wheel 56 can properly fits into a flat 182 adjacent a ribs 184 of a truck manufacturer different than shown in FIGS. 3 and 4. Alternatively, as shown in FIG. 27, J-type nut retainer 68 may be positioned further in direction 52 within opening 94 and bore 96, which moves roller frame 64 in direction 50 so as to position wheels 56 in flat 186 bordered by ribs 188. This demonstrates how roller frame 64 (and roller frame 65) of any of adjustable roller frame assemblies 14, 16, and 36 can be adjusted laterally in directions 50 or 52, as well as independently, to ensure wheels 56 fit on any of flats 42, 182, or 186, depending on the positioning of same within a cargo box.

Because tray 21 is movable on wheels 56 as previously described, it may, in some instances, be desirable to limit the extent to which tray 21 can move, particularly, in direction 26 and, particularly, when tailgate 6 is first opened. Accordingly, a secondary tether can be attached to tray 21 to limit the extent same can be initially moved from cargo box 2, until the secondary tether is disengaged.

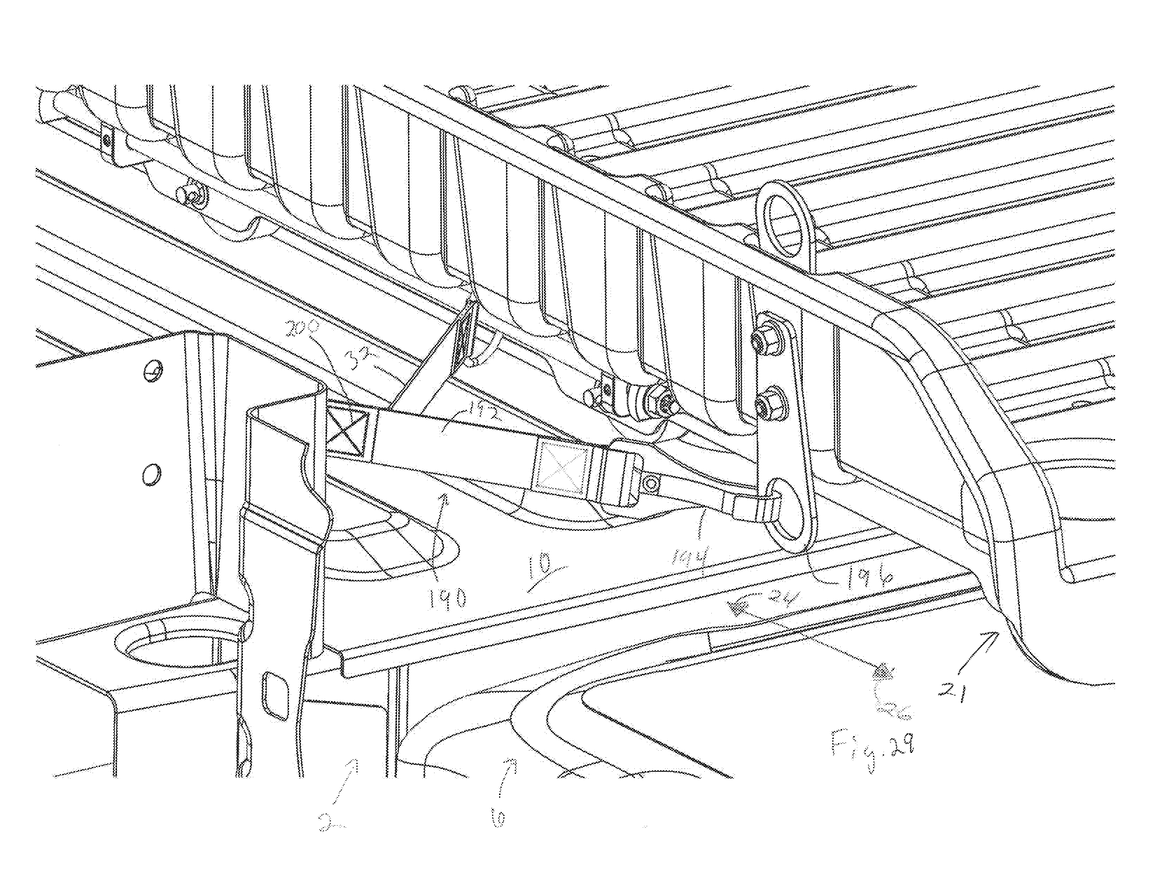

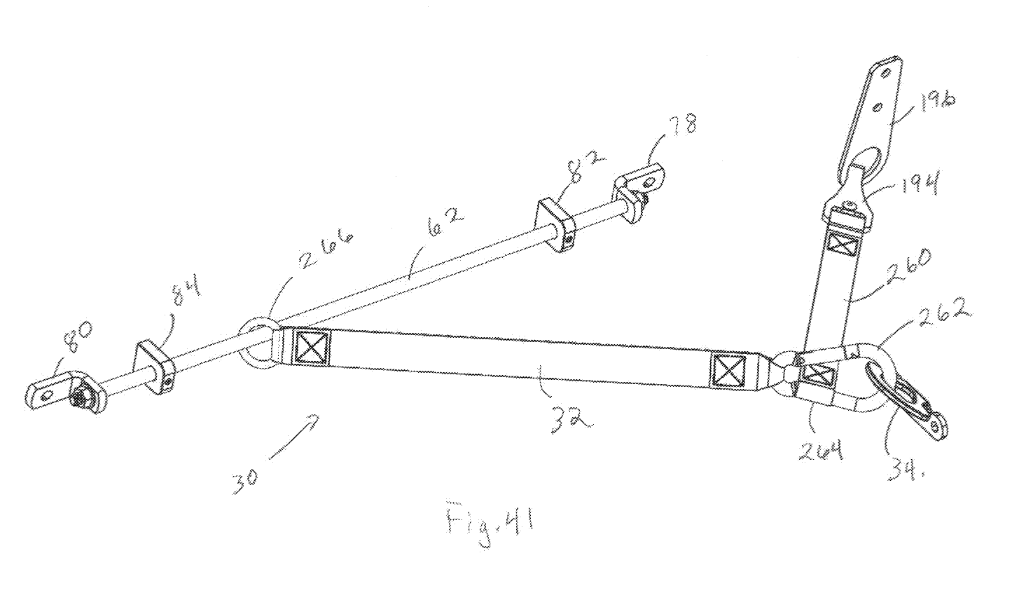

A detail perspective view of a portion of cargo box 2, with tray 21 of adjustable truck bed cargo tray assembly 12, is shown in FIG. 28. Tailgate 6 is shown in its lowered unlatched position. Here, tray 21 has not fully extended over tailgate 6 because a secondary tether assembly 190 is preventing tray 21 from extending significantly from cargo box 2 in direction 26. Secondary tether assembly 190 includes a strap portion 192 that is illustratively affixed to tether 32 of adjustable tether assembly 30. A clasp 194, which may also be a hook or other like structure, engages a tiedown 196 fastened, or otherwise located on sidewall 198 of tray 21. Based on the length of strap portion 192, the extent to which tray 21 can move in direction 26 is limited. A longer strap portion 192 allows tray 21 to extend further in direction 26. Conversely, a shorter strap portion 192 lessens the extent to which tray 21 can move in direction 26. In one embodiment, secondary tether assembly 190 may be employed on one side of cargo box 2. Illustratively shown herein is secondary tether assembly 190 located adjacent the cargo box side with adjustable tether assembly 30. Alternatively, a secondary tether assembly 190 can be used on the same side as adjustable tether assembly 28 instead of or in addition to adjustable tether assembly 30. Secondary tether assembly 190 may, alternately, include a separate strap or tether that can be connected to tiedown 34 or other structure independent of adjustable tether assembly 30, but still able to limit movement of tray 21 until released (see FIGS. 40-41).

A detail forward looking view of a portion of cargo box 2, with cargo box floor 10 and tailgate 6, is shown in FIG. 29. This view depicts secondary tether assembly 190 secured to both tether 32 and tiedown 196 to limit the extent to which tray 21 can extend in direction 26 from cargo box 2. Again, this prevents tray 21 from moving completely out of cargo box 2 when tailgate 6 is unlatched and lowered. This can have utility in circumstances when a pickup truck is parked on an incline which might otherwise cause tray 21 to roll out of cargo box 2 once tailgate 6 is open. As also shown in the illustrative embodiment, strap portion 192 is affixed to strap 32 via an illustrative stitching 200 at one end and an end clasp 194, engaging tiedown 196 at the other end. Clasp 194 may be a hook or other like structure that can engage the tiedown yet be easily removed by an operator when it is desired to have tray 21 move in direction 26. It is appreciated that in other embodiments, strap portion 32 can attach to tether 32 via fastener or like attachment structure while clasp 194 can be replaced with other selectively attaching structures. Additionally, tiedown 196 is illustrative. Other tiedown or securement structures may be used as an alternative.

Another illustrative embodiment of the present disclosure provides one or more tiedown rings fastened to the sidewall of the tray. Illustratively, the tiedown rings can be formed of a plate, tube, opening, or other like structure that can be fastened or otherwise attached to the sidewall or base of the tray. Again, further characteristics of the tray, as disclosed herein, can be found in US Patent Application No. 18/381286, titled “Adjustable Bedslide Deck,” again the disclosure of which is incorporated herein by reference in the entirety. Bungee cords, straps, partitions, etc. can hook or fasten onto the tiedown rings to provide securement points or create barriers to segregate sections of the tray, thereby adding further utility to same for the operator.

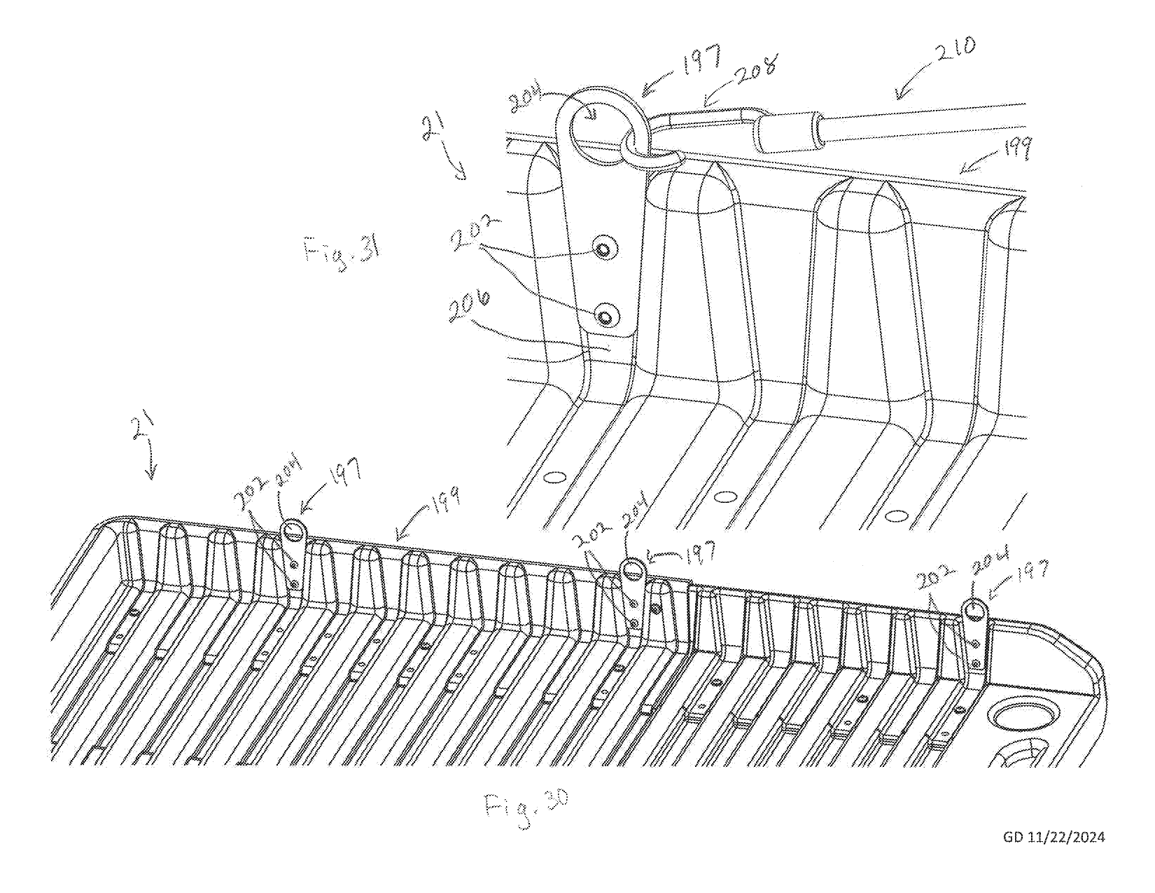

An isolated perspective view of a portion of tray 21, with a plurality of spaced apart tiedown rings 197 fastened to sidewall 199 via fasteners 202, is shown in FIG. 30. It is appreciated from this view how opening 204 sits above the top of sidewall 199 to provide convenience for the operator to attach any variety of structures to. It is also appreciated that, alternatively, openings for securement structures can be positioned below the top of sidewall 99, or any of the walls of tray 21. Multiple tiedown rings 197 are shown illustratively spaced apart along tray 21. It is further appreciated that tiedown rings 197 can be attached to any location along any part of tray 21 in any quantity and at any distance.

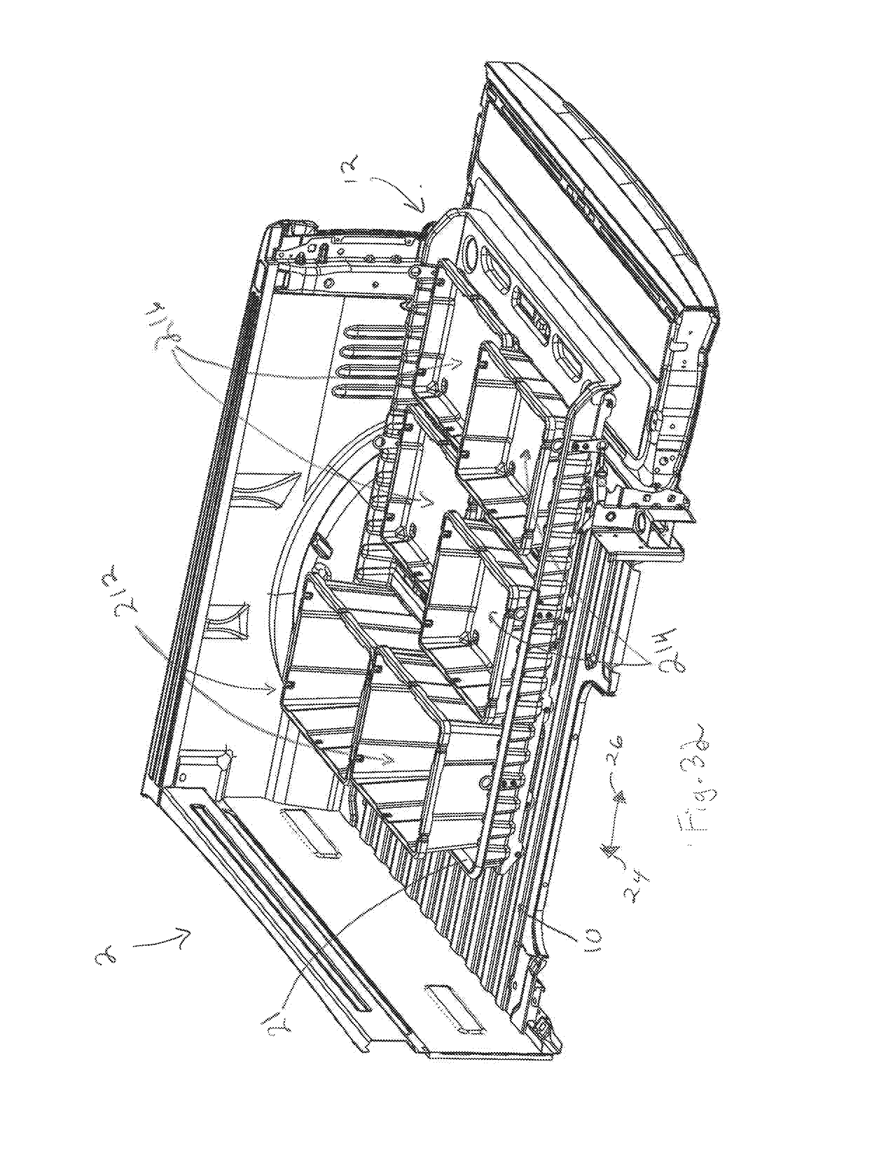

A detail perspective view of a portion of tray 21 with tiedown ring 197 fastened to sidewall 199 is shown in FIG. 31. Here, the plate structure of tiedown ring 197 is illustratively tapered to fit within a corresponding shape of indexing rib 206. Fasteners 202 are shown securing tiedown ring 197 to sidewall 199. It is appreciated that other means of attachment may be employed, such as friction fit, adhesive, or even integrally forming the tiedown ring with either sidewalls 199, as well as any other location on tray 21. This view further demonstrates a utility of hook 208 of bungee cord 210 hooking onto tiedown ring 197 through opening 204. Such hooks, fasteners, rods, ties, or other fastening structures can engage tiedown ring 197 for securement or segregation of tray 21. Using fasteners 202 or other attachment structures, an operator can place tiedown rings at any location on tray 21 and in any quantity as needed by an operator to create further utility of tray 21.

Another illustrative embodiment of the present disclosure provides a plurality of modular containers configured to fit within tray 21 (as well as the tray disclosed in US Patent Application No. 18/381286). Each modular container includes one or more feet that can be fitted within the recessed character of indexing rib 206 (as well as indexing rib 22 of US Patent Application No. 18/381286) to assist in preventing the modular container from moving in multiple directions while seated in the tray. Illustratively, the bottom of each container (which may also or alternatively be itself a tray) may have 2 feet or 4 feet, for example, fitted from its bottom to fit within multiple index ribs to limit movement fore or aft on tray 21. The modular container may still slide laterally unless held in place by bungee cords, straps, or other securement structures, but the container’s movement is limited fore and aft. This provides predetermined positive placement of each modular box within the tray.

It is appreciated that the feet can be square, rectangular, etc. as needed to effectively place the modular container in the tray and within an indexing rib and held in place. In another illustrative embodiment, the modular container can have tapered sidewalls depending from its top edge to its base. This allows multiple containers to be fitted within each other and stacked for storage purposes, or to create multiple storage configurations. For example, a first modular container can have the same top and bottom shape and size as a second modular container with the only difference being each modular container has a different height. The modular container with a deeper depth can receive the modular container with the shallower depth at the top, thereby nesting the shallower depth container within the deeper depth container. This can continue with a modular container of even shallower depth so that all of the containers can be stacked within each other. This assists in any variety of potential storage configurations. It also assists in allowing articles to be placed in the deeper container and covered by the shallower container. Then the shallow most container can be stacked on top of the shallower container and articles placed on top of the shallow most container. Such design options provide multiple configurations of utility for the operator.

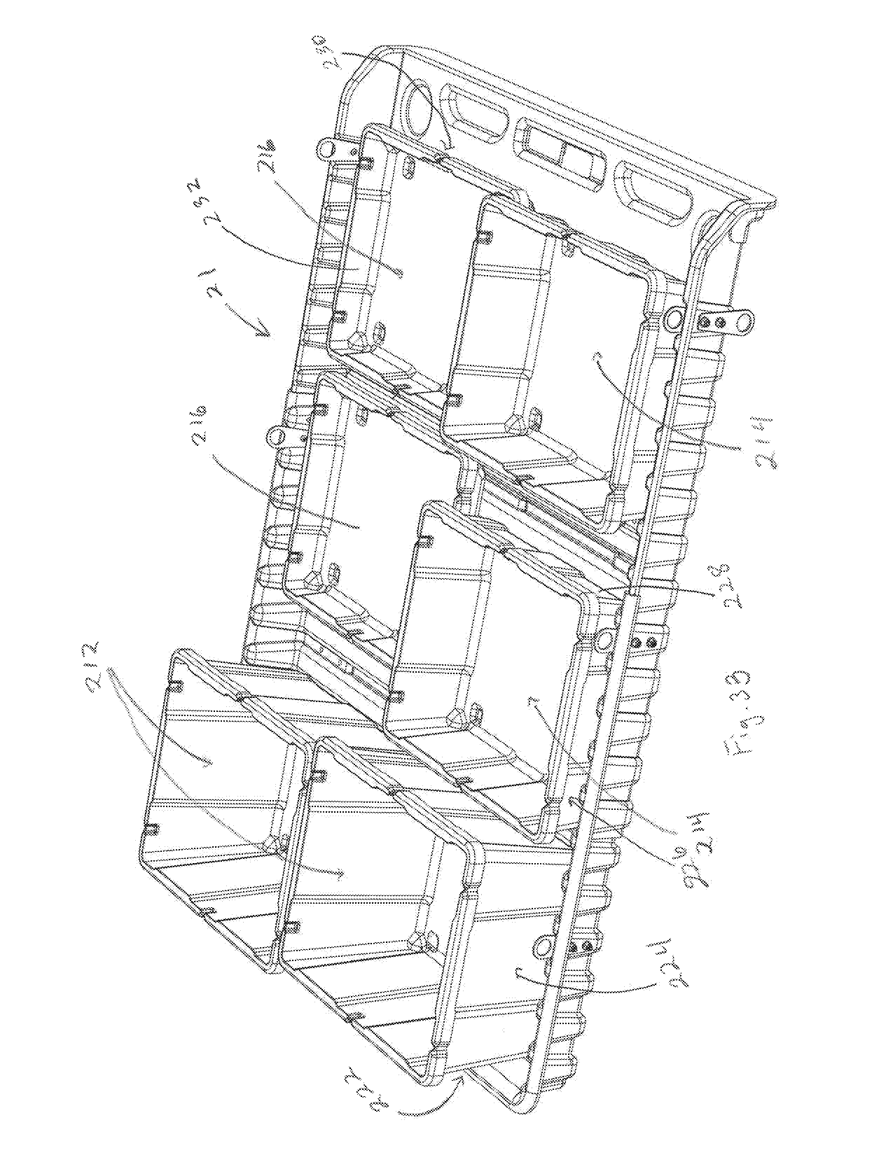

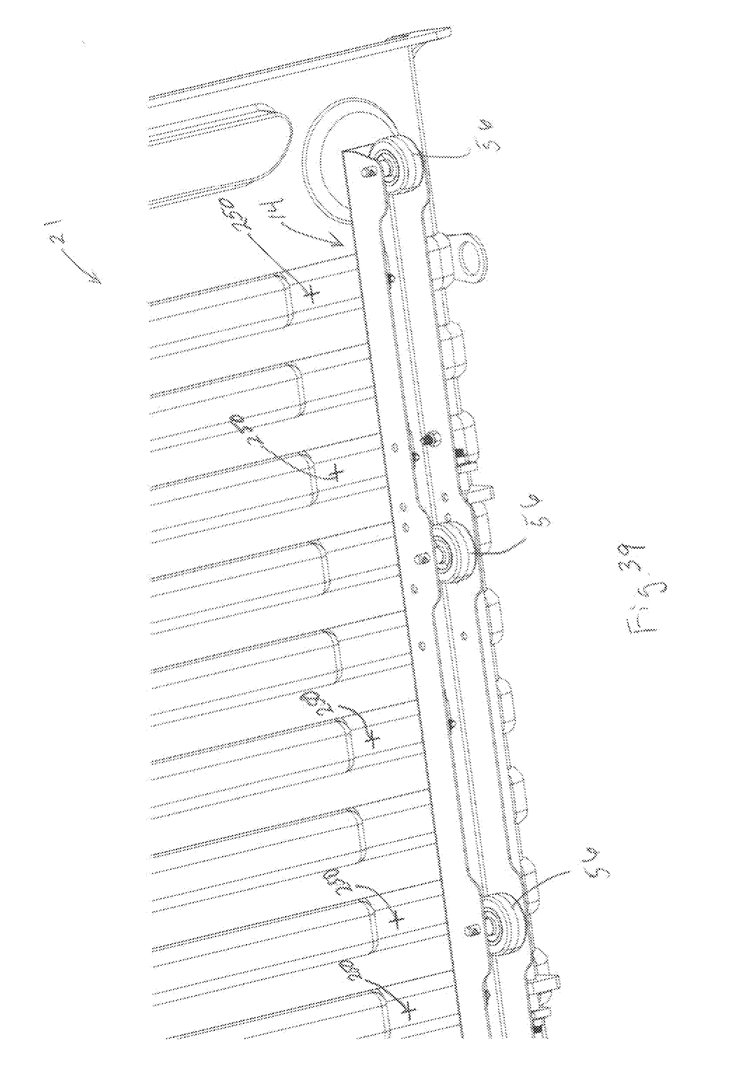

A perspective partial cutaway view of cargo box 2, with adjustable truck bed cargo tray assembly 12 fitted within and movable in directions 24 and 26, along cargo box floor 10, is shown in FIG. 32. Modular containers 212, 214, and 216 are shown fitted within tray 21. This view depicts how each of modular containers 212, 214, and 216 have different depths. However, illustratively, the size and configuration of their top peripheries 218, and their bottom bases 220 are the same size across each of the different modular containers. To be clear, the bottom bases of each of modular containers 212, 214, and 216 are each the same size, but smaller than the top peripheries 218 of those same modular containers 212, 214, and 216. Each of modular containers 212, 214, and 216 have tapered sidewalls, which allows modular container 214 to stack within modular container 212 and modular container 216 stack within modular container 214 (see FIG. 38). In this illustrative embodiment, it is appreciated that each of modular containers 212, 214, 216 are the same size, except that their depths are different (see, also, FIG. 38). This means that each of modular container 212, 214, and 216 can either be placed separately on tray 21 or stacked on top of each other.

An isolated perspective view of tray 21, with modular containers 212, 214, and 216, is shown in FIG. 33. This view is similar to that of FIG. 32, with cargo box 2 removed for demonstration purposes. This view further demonstrates the different depths of modular containers 212, 214, and 216. For example, modular container 212 has sidewalls 224 having a deep depth 222. Modular container 214 has sidewalls 228 with a depth 226, which is shallower than depth 222 of modular container 212. Modular container 216, in similar form, has sidewalls 232, each having a depth 230, which is shallower than both depths 228 and 222 of sidewalls 228 and 224 of modular containers 214 and 212, respectively. It is appreciated that the peripheries of each of the modular containers 212, 214, and 216 are the same meaning that modular container 216 can be stacked on modular container 214, which can be stacked on modular container 212 (see, also, FIG. 37).

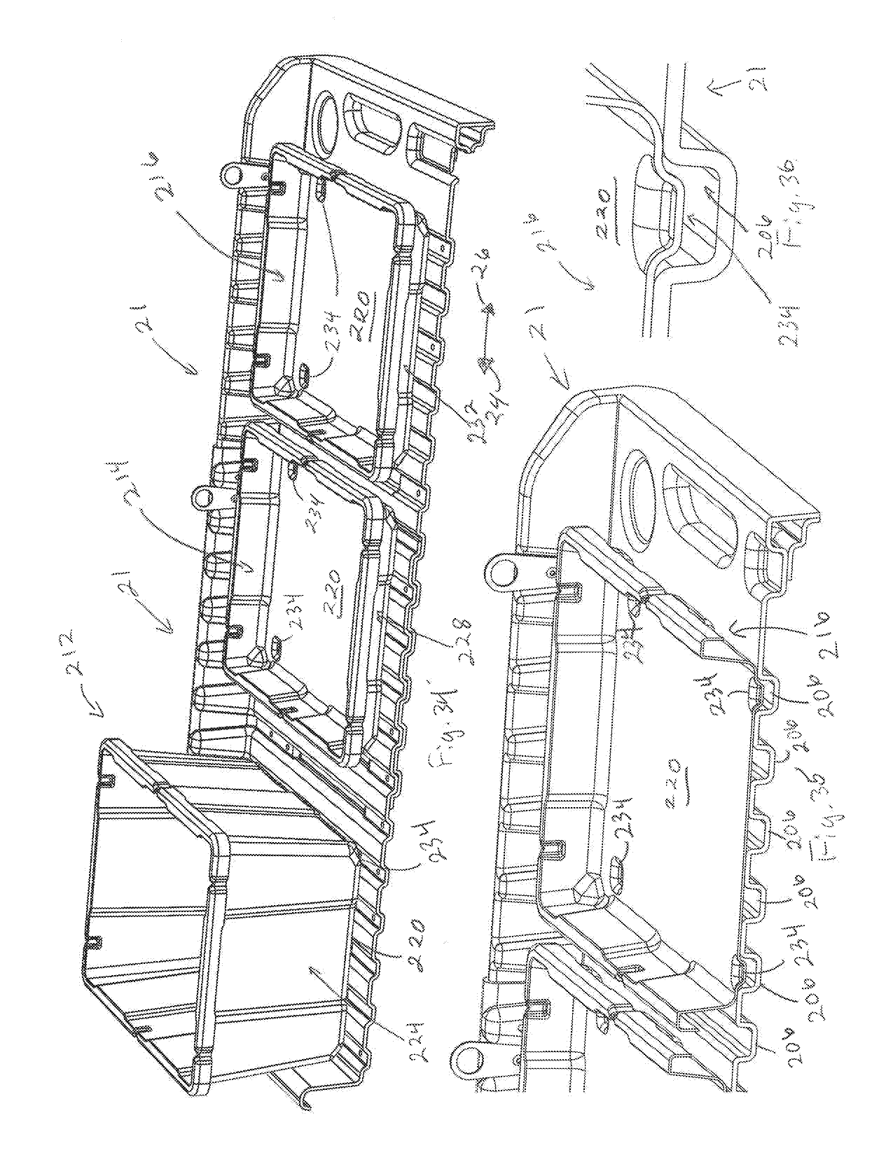

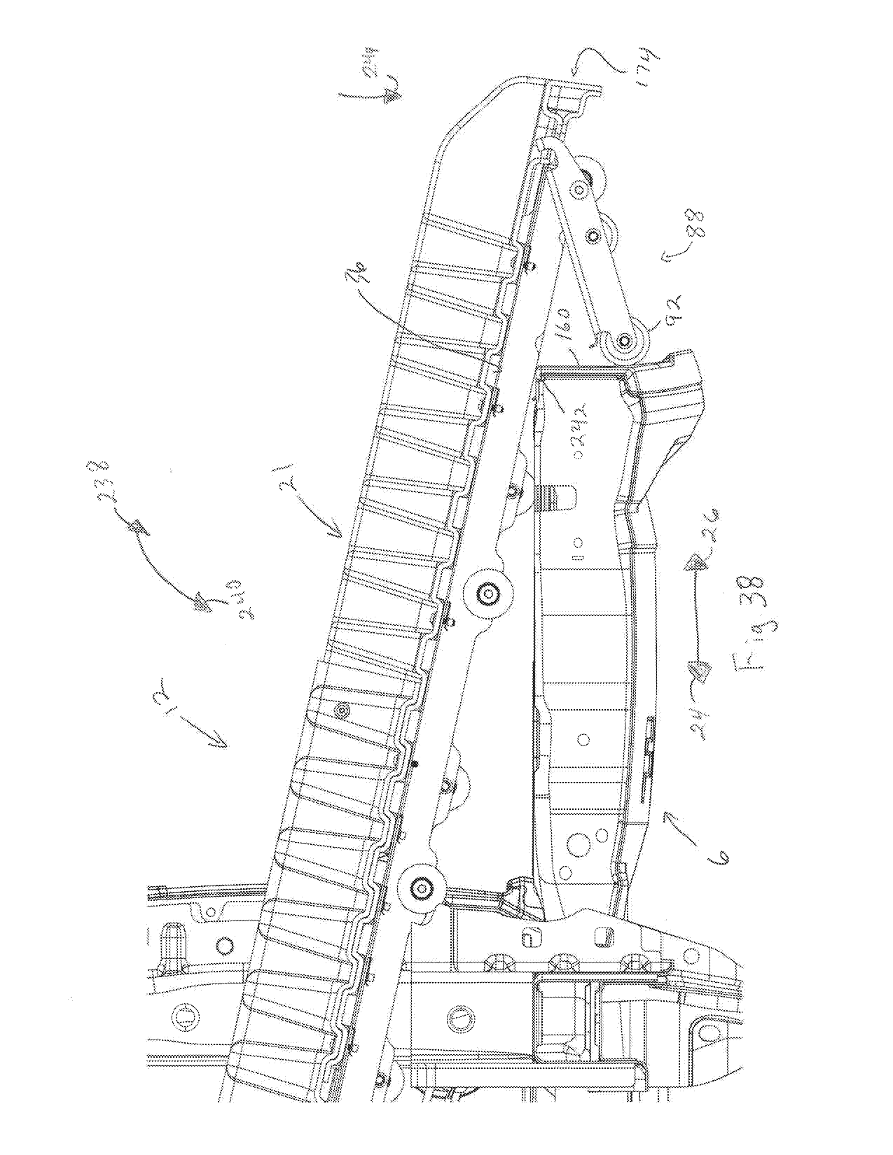

A cross-sectional side view of tray 21, with modular containers 212, 214, and 216 located thereon, is shown in FIG. 34. This view demonstrates how each of modular containers 212, 214, and 216 each include depending feet 234 configured to fit within indexing ribs 206 to positively place the modular containers on tray 21 and assist in preventing the modular containers from moving fore or aft when tray 21 is moving in either directions 24 or 26. In the illustrative embodiment, feet 234 are integrally formed by being molded into bottom base 220 of each of modular containers 212, 214, and 216 (see, also, FIG. 36). It is appreciated that such feet 234 can be separately attached by fastening, adhesive, etc., to depend from the modular containers and fit within indexing rib 206. Additionally, despite being located at each of the corners of the modular containers, it is contemplated that depending feet 234 can be placed anywhere on bottom base 220 or even on the sidewalls 224, 228, or 232 of modular containers 216, respectively. When tray 21 is slid out from cargo box 2 in direction 26, feet 234 assists in keeping the modular container from continuing to slide in direction 26 when tray 21 has stopped moving. Conversely, when tray 21 is recessed back into cargo box 2 in direction 24, feet 234 assists in keeping the modular containers in place and not continuing to move in direction 24 when tray 21 has stopped moving in that direction.

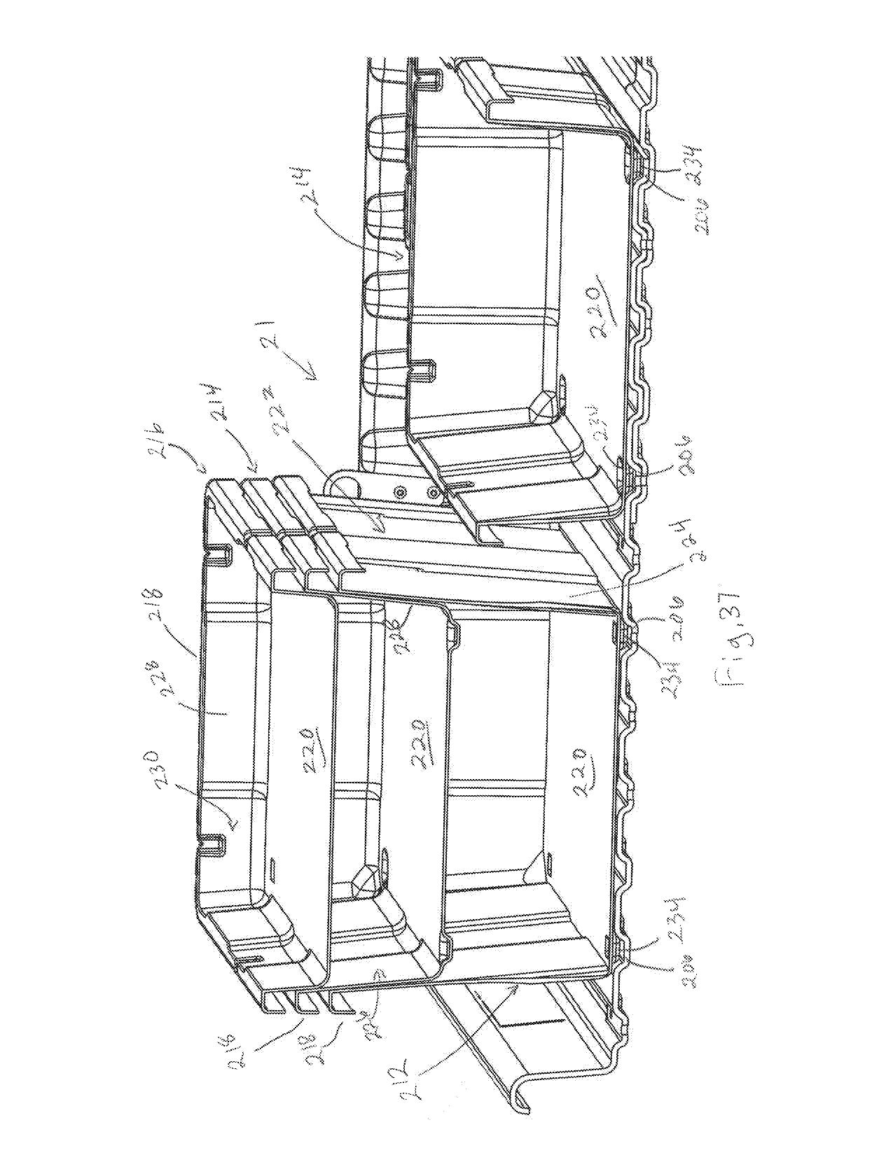

A detail sectional view of tray 21, with modular container 216 positioned thereon, is shown in FIG. 35. Here, feet 234 are illustratively shown positioned at the corners of modular container 216 and depending into indexing rib 206. It is appreciated that tray 21, having multiple indexing ribs 206, periodically laterally spaced along tray 21, offers a myriad of storage positions for modular container 216 (as well as modular containers 212 and 214 and not move fore or aft). Again, it is appreciated that feet 234 may be configured and located in any variety of configurations and locations on the modular container as desired so long as they are fitable within at least one indexing rib 206.

A detail side view of a portion of modular container 216 and tray 21, with depending feet 234 extended into indexing rib 206, is shown in FIG. 36. This view further emphasizes how depending feet 234 extending from base 220 fits within indexing rib 206 to hold modular container 216 in place. It is appreciated that this configuration shown is the same with respect to each of the depending feet 234 of modular container 216, as well as modular containers 214 and 212.

Another sectional view of a portion of tray 21, with modular containers 212, 214, and 216 located thereon, is shown in FIG. 37. This view demonstrates how modular container 214 can be stacked on modular container 212 and modular container 216 stacked on modular container 214 to stack all three modular containers 212, 214, and 216 together. Again, it is appreciated that in this illustrative embodiment, top peripheries 218 and bottom bases 220 of each of modular containers 212, 214, and 216 are the same size and configuration. In other words, their dimensions across each of the modular containers 212, 214, and 216 are the same. The only significant difference is each of their depths. Modular container 214 has depth 222 of each of sidewalls 224 extending deeper than depth 226 of each of sidewalls 228 of modular container 214. Similarly, depth 230 of sidewall 228 is shallower than depth 226 of sidewalls 224 of modular container 214. Additionally, the length and width of top peripheries 218 of each of modular containers 212, 214, and 216, albeit the same are greater than the length and width of bottom bases 220. This means that each of sidewalls 224, 228, and 232 are tapered from top to bottom. This is what allows each of modular containers 216 and 214 to be stacked on top of each other, and then be stacked on top of modular container 212 as shown. This makes all the different depths 222, 226, and 228, of modular containers 212, 214, and 216, still able to stack in this consolidated fashion.

This view also demonstrates that despite all the different depths, articles can still be placed within modular containers 212, 214, and 216 while the same stack on top of each other. It is also appreciated from this view how feet 234 extends downwardly from bottom base 220 and fit within respective indexing ribs 206 holding the modular containers in place. It is further appreciated that with respect to depending feet 234 and indexing ribs 206, each can be configured so that, for example, a depending foot 234 can be friction fit or otherwise removably held within indexing rib 206. This can create a snap fit to hold the modular container in place within indexing ribs 206.

Another illustrative embodiment of adjustable truck bed cargo tray assembly 12 is its ability for tray retraction stop assembly 88 to also serve as a tray tip limiter. An advantage of adjustable truck bed cargo tray assembly 12 is its ability to move tray 21, particularly, its leading edge 174, beyond end surface 160 of tailgate 6. This provides an operator significant access to tray 21 without cargo box 2 itself serving as an impediment to that access. The extent of that access is defined and limited by the extent to which adjustable tether assemblies 28 and 30 allow tray 21 to extend in direction 26 from tailgate 6. Because of this significant access, as well as the relative light weight of adjustable truck bed cargo tray assembly 12, there could be an unlikely instance when adjustable truck bed cargo tray assembly 12 might tip forward creating a potentially undesirable and unintended condition of tray 21 (in alternative circumstances, there may be utility allowing tray 21 to tilt forward under certain circumstances as dictated by the operator). To limit the extent to which adjustable truck bed cargo tray assembly 12 can tilt forward, tray retraction stop assembly 88, when suspended past tailgate 6 and wheel 92, abuts end surface 160 of tailgate 6. Tray retraction stop assembly 88, essentially, stops the extent to which tray 21 can tilt forward.

A side detail sectional view of a portion of cargo box 2, with tailgate 6 lowered and a portion of adjustable truck bed cargo assembly 12 extending therefrom, is shown in FIG. 38. This figure is similar to that shown in FIG. 18, for example, except that in FIG. 38, adjustable truck bed cargo tray assembly 12 is tilted forward in direction 238. Although leading edge 174 of tray 21 extends past tailgate 6 as allowed by adjustable tether assemblies 28 and 30, adjustable truck bed cargo tray assembly 12 can be tilted forward. In some instances, such tilt in direction 238 may be desired by the operator. In other instances, such tilt in direction 238 may be accidental and unwanted. In either case, with tray retraction stop assembly 88 deployed and wheel 92 abutting end surface 160 of tailgate 6, as shown in FIG. 38, the extent of forward tilt in direction 238 is limited to that shown.

Because corner 242 of tailgate 6 can serve as a fulcrum or pivot point placing a downward force in direction 244, that arrangement may cause adjustable truck bed cargo tray assembly 12 to essentially rotate about corner 242. Having adjustable tray retraction stop assembly 88 attached adjacent the front end of tray 21 (via adjustable roller frame assembly 36) and wheel 92 abutting end surface 160 adjustable truck bed cargo tray assembly 12 is stopped from rotating or tilting forward any further in direction 238. This means adjustable truck bed cargo tray assembly 12 can only tilt forward some extent before adjustable tray retraction stop assembly 88 stops it. Again, this can provide additional utility to the operator by allowing some degree of forward tilt if such utility demands it while at the same time limiting that tilt if it is inadvertent.

Furthering the views of FIGS. 22-27, there may be instances when having no pre-drill bores through tray 21 is desirable. For example, if tray 21 is intended to be used in an environment where fluid could seep onto tray 21 the operator may not want that fluid leaking onto cargo box floor 10 underneath. Accordingly, a detail underside perspective view of a portion of tray 21 with adjustable roller frame assembly 14 attached thereto is shown in FIG. 39. As an alternative to having a plurality of spaced apart pre-drilled bores to allow different positioning of adjustable roller frame assemblies 14, 16, or 36 to accommodate different cargo box designs, one or more drill markings 250 can be placed on the surface of tray 21. Any number of drill markings can be placed and spaced apart on tray 21 to accommodate any variety of different cargo box designs. A skilled artisan upon reading this disclosure will appreciate that this allows an operator to choose which set of drill markings 250 best align with a particular cargo box design that adjustable truck bed cargo tray assembly 12 will be installed in and then drill through tray 21 only as needed. Having only bores that will be filled by fasteners reduces the potential for errant fluid collected on tray 21 to leak through otherwise unused predefined fastener holes such as fastener holes 33 shown in FIG. 21.

Furthering the views of FIGS. 28-29, an alternative embodiment of a secondary tether includes attaching same to a quick link or carabiner that itself attaches to a tiedown and tether. A detail perspective view of portion of cargo box 2 with tray 21 of adjustable truck bed cargo tray assembly 12 is shown in FIG. 40. This view is similar to that shown in FIG. 28 except that a secondary tether 260 is directly attached to carabiner 262 instead of tether 32. Illustratively, a loop 264 can be formed at an end of secondary tether 260 opposite clasp 194 that receives a portion of carabiner 262. Secondary tether 260 may serve the same function as that described with respect to secondary strap portion 192 except for the manner and location secondary tether 260 is attached to adjustable truck cargo bed tray assembly 12. It is appreciated that a ring, clasp, or like structure may be used to attach secondary tether 260 to carabiner 262 or to tiedown 34 directly.

An isolated detail perspective view, similar to that of FIG. 10, including adjustable tether assembly 30 with secondary tether 260 attached thereto, is shown in FIG. 41. This view further demonstrates how secondary tether 260 includes illustrative loop 264 wrapped around carabiner 262 which itself is secured to tiedown 34. Also shown is secondary tether 260 attached to clasp 194 which itself is attached to tiedown 196. This view Further demonstrates, illustratively, how carabiner 262 and ring 266 can be used in place of, an serve the same function as, quick link 60 herein.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed:

1. An adjustable cargo tray assembly for a cargo box of a vehicle, comprising:
a tray having a first deck portion and a second deck portion, the first deck portion and the second deck portion being selectively overlapped to adjust an overall length of the tray;
at least two adjustable roller frame assemblies, each of the adjustable roller frame assemblies including:
a first roller frame and a second roller frame telescopically received within the first roller frame and extendable or retractable to adjust a length of each of the adjustable roller frame assemblies; and
a plurality of wheels mounted on the each of the adjustable roller frame assemblies to allow rolling movement of the tray along a cargo box floor;
wherein each of the adjustable roller frame assemblies is secured to the adjustable cargo tray assembly at selected positions under said tray to align the plurality of wheels with flat regions on the cargo box floor, whereby the tray and the adjustable roller frame assemblies are adjustable to fit cargo boxes of a plurality of configurations.

2. The adjustable cargo tray assembly of claim 1, wherein each of the adjustable roller frame assemblies includes a plurality of retainers that secure the each of the adjustable roller frame assemblies to the tray.

3. The adjustable cargo tray assembly of claim 1, wherein each of the adjustable roller frame assemblies includes at least one retainer that secures the each of the adjustable roller frame assemblies to the tray.

4. The adjustable cargo tray assembly of claim 2, wherein the tray includes a plurality of recesses with fastener holes each configured to receive a retainer of the plurality of retainers to secure the each of the adjustable roller frame assemblies to the tray.

5. The adjustable cargo tray assembly of claim 1, wherein the plurality of wheels are positioned within channels formed by at least one leg on the each of the adjustable roller frame assemblies.

6. The adjustable cargo tray assembly of claim 1, wherein markings are provided on the tray to guide drilling of fastener holes for custom positioning of the each of the adjustable roller frame assemblies.

7. The adjustable cargo tray assembly of claim 1, wherein the each of the adjustable roller frame assemblies is independently laterally adjustable under the tray.

8. The adjustable cargo tray assembly of claim 1, further comprising at least one adjustable tether assembly having a tether extendably coupled to the adjustable cargo tray assembly and configured to couple to a tie-down of the cargo box.

9. The adjustable cargo tray assembly of claim 8, wherein the at least one adjustable tether assembly includes a tether rod mounted to at least one of the adjustable roller frame assemblies via one or more spaced-apart brackets, wherein the tether is coupled to the tether rod and configured to couple to the tie-down of the cargo box.

10. The adjustable cargo tray assembly of claim 9, wherein the at least one adjustable tether assembly includes a stop block adjustably positionable along the tether rod to limit movement of the tray in at least an extend direction.

11. The adjustable cargo tray assembly of claim 10, wherein the stop block is selectively securable to the tether rod via a setscrew disposed through the stop block.

12. The adjustable cargo tray assembly of claim 9, wherein the tether is removably attachable to the tether rod and configured to be removably attachable to the tie-down of the cargo box.

13. The adjustable cargo tray assembly of claim 12, further comprising a secondary tether configured to be attached to the tether and coupled to the tray to restrict movement of the tray until the secondary tether is uncoupled from the tray.

14. The adjustable cargo tray assembly of claim 1, further comprising a tray retraction stop assembly pivotally mounted on at least one adjustable roller frame assembly adjacent a leading edge of the tray.

15. The adjustable cargo tray assembly of claim 14, wherein the tray retraction stop assembly includes a stop frame configured to pivot downward when the tray is extended past a lowered tailgate.

16. The adjustable cargo tray assembly of claim 15, wherein the tray retraction stop assembly includes at least one wheel mounted to the stop frame configured to engage an end surface of the lowered tailgate and inhibit unintentional retraction of the tray.

17. The adjustable cargo tray assembly of claim 16, wherein the tray retraction stop assembly includes a handle configured to be operable by a user to pivot the stop frame upward to clear the lowered tailgate to permit the retraction of the tray into the cargo box.

18. The adjustable cargo tray assembly of claim 17, wherein the tray retraction stop assembly includes spaced-apart wheels configured to prevent the stop frame from dropping into a gap between the cargo box floor and the lowered tailgate, wherein the stop frame further limits forward tilting of the tray when extended past the lowered tailgate, and wherein the handle is accessible by an opening in the tray near the leading edge.

19. An adjustable cargo tray assembly for a cargo box of a vehicle, comprising:
a tray having a first deck portion and a second deck portion, the first deck portion being selectively adjustable with respect to the second deck portion to adjust an overall length of the tray;
at least one adjustable roller frame assembly including:
a first roller frame and a second roller frame telescopically received within the first roller frame and extendable or retractable to adjust a length of the at least one adjustable roller frame assembly; and
a plurality of wheels mounted on the at least one adjustable roller frame assembly to allow rolling movement of the tray along a cargo box floor.

20. The adjustable cargo tray assembly of claim 19, wherein the at least one adjustable roller frame assembly is secured to the adjustable cargo tray assembly at selected positions under said tray to align the plurality of wheels with flat regions on the cargo box floor, wherein the tray and roller frame assemblies are adjustable to fit cargo boxes of a plurality of configurations.
